(19) United States
(12) Patent Application Publication
(10) Pub. No.: US 2025/0197158 A1
(43) Pub. Date: Jun. 19, 2025

(54) SHEET BINDING PROCESSING APPARATUS AND IMAGE FORMING SYSTEM INCLUDING SHEET BINDING PROCESSING APPARATUS

(71) Applicant: CANON FINETECH NISCA INC., Saitama (JP)

(72) Inventors: Daiki Komiyama, Yamanashi-ken (JP); Tadahito Takano, Yamanashi-ken (JP); Keiichi Nagasawa, Yamanashi-ken (JP); Tatsuya Shimizu, Yamanashi-ken (JP)

(21) Appl. No.: 18/978,224

(22) Filed: Dec. 12, 2024

(30) Foreign Application Priority Data
Dec. 15, 2023 (JP) 2023-212307
Oct. 30, 2024 (JP) 2024-190841

(51) Int. Cl. B65H 37/04; B42B 5/00; B65H 29/12; B65H 29/60; B65H 37/06; G03G 15/00

(52) U.S. Cl. CPC B65H 37/04; B65H 29/125; B65H 29/60; G03G 15/6544; B42B 5/00; B65H 37/06; B65H 2301/4213; B65H 2408/12; G03G 2215/00936

(57) ABSTRACT

A sheet binding processing apparatus includes a control unit configured to, when performing the binding process for continuously binding a sheet bundle including a predetermined sheet which is larger than a predetermined length in a conveyance direction, control a conveyance unit, a buffer conveyance unit, and an upper conveyance unit such that a sheet that forms a subsequent sheet bundle is sent from a conveyance path to an upper branching path, and the sheet is then conveyed in a switchback direction from an upper branching path to a buffer path.

### BACKGROUND OF THE INVENTION

### Field of the Invention

The present invention relates to a sheet binding processing apparatus capable of executing binding processing for a sheet with an image formed thereon, and an image forming system including the sheet binding processing apparatus.

### Description of the Related Art

A sheet post-processing apparatus is known as an apparatus connected to the discharge port of an image forming apparatus and configured to temporarily hold, on a tray, a sheet with an image formed, perform post-processing, and store the sheet in a storage stacker. As the post-processing, processing of stacking sheets and binding a sheet bundle is known.

Japanese Patent Laid-Open No. 2013-230891 describes a sheet loading apparatus capable of preventing a deviation when aligning a plurality of sheets loaded on a loading tray. Japanese Patent Laid-Open No. 2018-47964 discloses an apparatus in which, to improve productivity in continuous bundle processing, if sheets of a subsequent bundle are conveyed during post-processing of a preceding bundle, the sheets are switchback-conveyed and buffered.

### SUMMARY OF THE INVENTION

When continuously performing bundle processing, in the buffer operation disclosed in Japanese Patent Laid-Open No. 2018-47964, it is impossible to feed a sheet onto the processing tray and buffer it. For example, when a bundle under processing or discharge is nipped by a discharge roller, a subsequent sheet whose length is longer than a predetermined length is blocked by the discharge roller and cannot be buffered.

The present invention provides a sheet binding processing apparatus capable of performing a buffer operation even if a subsequent sheet whose length is longer than a predetermined length is accepted during post-processing, and an image forming system including the sheet binding processing apparatus.

The present invention in one aspect provides a sheet binding processing apparatus comprising: a conveyance path configured to convey a sheet from a path inlet to a path outlet; a conveyance unit provided in the conveyance path and configured to convey the sheet; a tray configured to accept, from above, the sheet conveyed on the conveyance path; a binding unit configured to perform a binding process for binding a sheet bundle on the tray; a pair of discharge rollers configured to discharge the sheet bundle that is performed the binding process by the binding unit; a buffer path branching downward from the conveyance path and configured to, if a preceding sheet bundle exists on the tray, buffer a sheet that forms a subsequent sheet bundle; a buffer conveyance unit provided on the buffer path and configured to convey the sheet; an upper branching path branching upward from the conveyance path; an upper conveyance unit provided on the upper branching path and configured to convey the sheet; and a control unit configured to, when performing the binding process for continuously binding a sheet bundle including a predetermined sheet which is longer than a predetermined length in a conveyance direction, control the conveyance unit, the buffer conveyance unit, and the upper conveyance unit such that a sheet that forms a subsequent sheet bundle is sent from the conveyance path to the upper branching path, and the sheet is then conveyed in a switchback direction from the upper branching path to the buffer path.

According to the present invention, it is possible to buffer a subsequent sheet whose length is longer than a predetermined length even if a sheet exists on a processing tray.

Further features of the present invention will become apparent from the following description of exemplary embodiments with reference to the attached drawings.

### BRIEF DESCRIPTION OF THE DRAWINGS

FIG. 1 is a view showing the outer appearance of an image forming system;

FIG. 2 is a view showing the configuration of a sheet post-processing apparatus;

FIG. 3 is a view showing a configuration near a straight path;

FIG. 4 is a view showing the configuration of a punch unit;

FIG. 5 is a view showing the configuration of a punch unit;

FIG. 6 is a view for explaining the shift mechanism of a conveyance roller;

FIG. 7 is a view for explaining the shift mechanism of a conveyance roller;

FIG. 8 is a view for explaining a binding processing mechanism;

FIG. 9 is a view for explaining a binding processing mechanism;

FIG. 10 is a view for explaining a binding processing mechanism;

FIG. 11 is a view for explaining an elevating mechanism for a tray;

FIGS. 12A to 12C are views for explaining a sheet unloading mechanism;

FIG. 13 is a view showing the configuration of a staple unit;

FIG. 14 is a view showing a configuration on the periphery of a control unit;

FIGS. 15A and 15B are views for explaining sheet conveyance;

FIGS. 16A and 16B are views for explaining sheet conveyance;

FIGS. 17A and 17B are views for explaining sheet conveyance;

FIGS. 18A and 18B are views for explaining sheet conveyance;

FIGS. 19A and 19B are views for explaining sheet conveyance;

FIGS. 20A and 20B are views for explaining sheet conveyance;

FIGS. 21A and 21B are views for explaining sheet conveyance;

FIGS. 22A and 22B are views for explaining sheet conveyance;

FIGS. 23A and 23B are views for explaining sheet conveyance;

FIGS. 24A and 24B are views for explaining sheet conveyance;

FIGS. 25A and 25B are views for explaining sheet conveyance;

FIGS. 26A and 26B are views for explaining sheet conveyance;

FIGS. 27A and 27B are views for explaining sheet conveyance;

FIGS. 28A and 28B are views for explaining sheet conveyance;

FIG. 29 is a view for explaining sheet conveyance; and

FIGS. 30A to 30C are views showing a configuration on the periphery of a processing unit buffer path flapper.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### Image Forming Apparatus

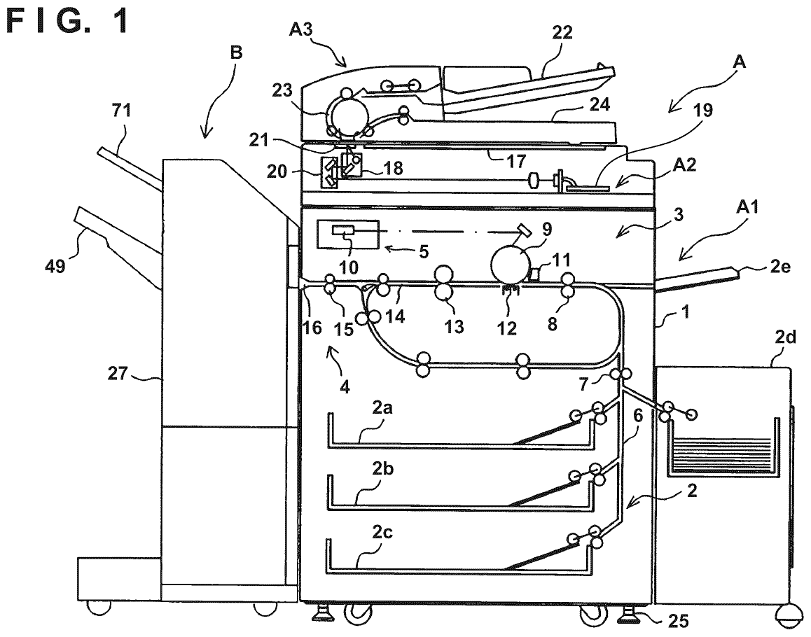

An image forming apparatus A in an image forming system shown in FIG. 1 will be described. The image forming apparatus A shown in FIG. 1 indicates an electrostatic printing mechanism and is configured to include an image forming unit A1, a scanner unit A2, and a feeder unit A3. On an apparatus housing 1, installation legs 25 installed on an installation surface (for example, a floor surface) are provided. Also, a feeding unit 2, an image forming unit 3, a discharge unit 4, and a data processing unit 5 are incorporated in the apparatus housing 1.

The feeding unit 2 is configured to include cassette mechanisms 2a to 2c that store sheets of a plurality of sizes to form images, and feeds a sheet of a size designated by a main body control unit 90 to a feeding path 6. Hence, the plurality of cassettes 2a to 2c are detachably arranged in the apparatus housing 1, and each cassette incorporates a separation mechanism that separates the sheets inside one by one, and a feeding mechanism that feeds the sheets. In the feeding path 6, conveyance rollers 7 that feed sheets supplied from the plurality of cassettes 2a to 2c to the downstream side are provided, and a registration roller pair 8 that aligns the leading edge of each sheet is provided at the path end portion.

Note that a large-capacity cassette 2d and a manual tray 2e are connected to the feeding path 6. The large-capacity cassette 2d is configured to include an optional unit that stores sheets of a size to be consumed a lot. The manual tray 2e is configured to supply a special sheet difficult to separately feed, such as a thick sheet, a coating sheet, or a film sheet.

The image forming unit 3 is shown as an example of an electrostatic printing mechanism, and a photosensitive member 9 (a drum or a belt) is provided, and a light emitting device 10 that emits an optical beam to the photosensitive member 9, a developing device 11 (developer), and a cleaner (not shown) are arranged around the rotating photosensitive member. The illustrated mechanism indicates a monochrome printing mechanism, in which a latent image is optically formed on the photosensitive member 9 by the light emitting device 10, and the developing device 11 adheres toner ink to the latent image. In accordance with a timing of forming an image on the photosensitive member 9, a sheet is fed from the feeding path 6 to the image forming unit 3, and the image is transferred to the sheet by a transfer charger 12 and fixed by a fixing unit (roller) 13 arranged in a discharge path 14. In the discharge path 14, discharge rollers 15 and a discharge port (path outlet) 16 are arranged, and the sheet is conveyed to a sheet post-processing apparatus B to be described later.

The scanner unit A2 is configured to include a platen 17 on which an image original is placed, a carriage 18 that reciprocally moves along the platen 17, a light source mounted on the carriage 18, and a reduction optical system 20 (a combination of mirrors and lenses) that guides reflected light from the original on the platen 17 to a photoelectric conversion unit 19. Reference numeral 21 in FIG. 1 denotes a second platen (traveling platen) that performs image reading, by the carriage 18 and the reduction optical system 20, for a sheet fed from the feeder unit A3. The photoelectric conversion unit 19 transfers photoelectrically converted image data to the image forming unit 3.

The feeder unit A3 is configured to include a feeding tray 22, a feeding path 23 that guides a sheet fed from the feeding tray to the traveling platen 21, and a discharge tray 24 that stores the original that has undergone image reading by the platen.

The image forming apparatus A is not limited to the above-described mechanism, and a printing mechanism such as an offset printing mechanism, an inkjet printing mechanism, or an ink ribbon transfer printing mechanism (thermal transfer ribbon printing, sublimation ribbon printing, or the like) can be employed.

### Sheet Post-Processing Apparatus

As an apparatus that post-processes a sheet discharged from the discharge port 16 of the image forming apparatus A, the sheet post-processing apparatus B has, for example, (1) a function of loading and storing sheets with images formed thereon (printout mode), (2) a function of sorting and storing sheets with images formed thereon (jog sorting mode), (3) a function of aligning, stacking, and binding sheets with images formed thereon (binding processing mode), and (4) a function of aligning and binding sheets with images formed thereon and then folding the sheets to do bookbinding-finishing (bookbinding processing mode).

Note that in this embodiment, the sheet post-processing apparatus B need not have all the functions described above and is configured appropriately in accordance with apparatus specifications (design specifications). In this embodiment, as an example, the sheet post-processing apparatus B is assumed to have the function of aligning and binding sheets with images formed thereon and then folding the sheets to do bookbinding-finishing.

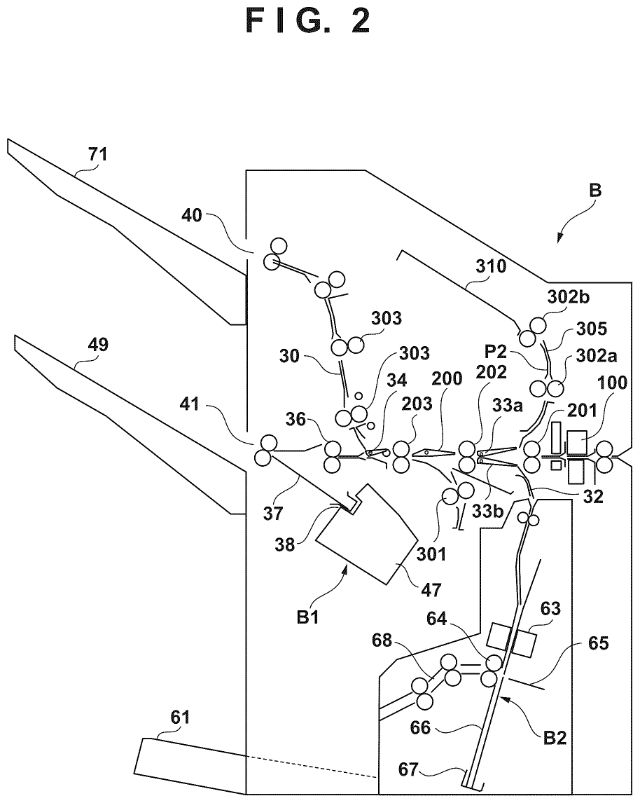

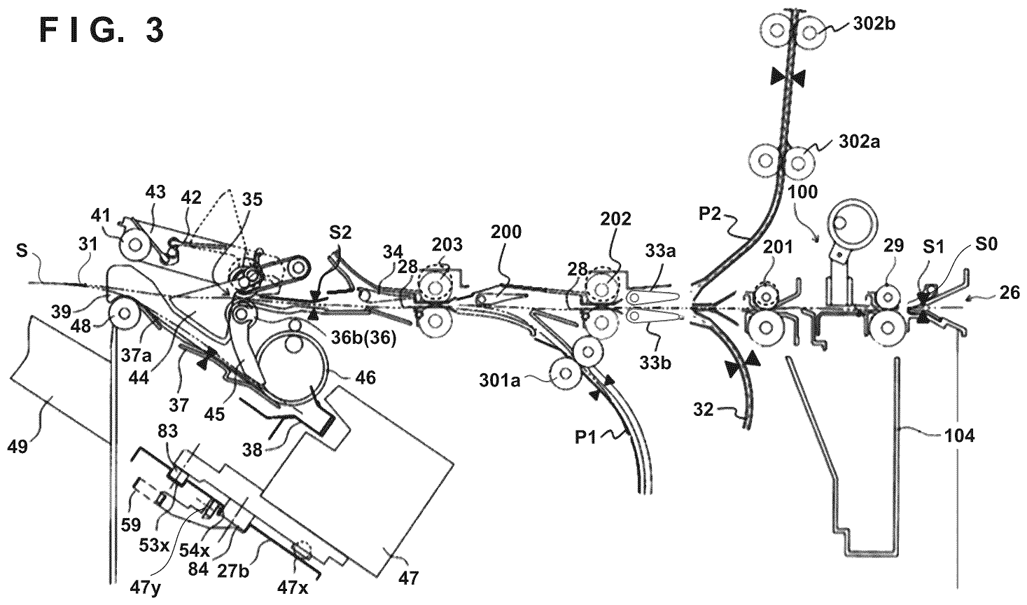

FIG. 2 shows the configuration of the sheet post-processing apparatus B, and FIG. 3 shows a configuration near a straight path 28. The sheet post-processing apparatus B post-processes a sheet loaded from a straight path inlet 26 connected to the discharge port 16 of the image forming apparatus A and then stores it in a storage unit (a first stack tray 49, a second stack tray 61, and a third stack tray 71 to be described later). The apparatus shown in FIG. 2 transfers the sheet sent to the straight path 28 from a processing unit B1 including a binding unit 47 to the first stack tray 49 (to be referred to as the “first tray” hereinafter) and the third stack tray 71 (to be referred to as the “third tray” hereinafter). The apparatus shown also transfers the sheet sent to the straight path 28 from a saddle unit B2 to the second stack tray 61 (to be referred to as the “second tray” hereinafter). Note that the straight path 28 is formed into a substantially linear shape and can therefore convey even a thick sheet.

The processing unit B1 is arranged at the path outlet (straight path discharge port 35) of the straight path 28, and aligns, stacks, and binds sequentially sent sheets and then stores these in the first tray 49. The saddle unit B2 is a post-processing unit that is arranged at the path outlet (saddle path discharge port) of a saddle path 32 branched from the straight path 28 and aligns, stacks, and saddle-stitches (sometimes does not saddle-stitch) sequentially sent sheets, then folds the sheets, and stores these in the second tray 61. The components will be described below in detail.

### <Apparatus Housing>

As shown in FIG. 2, the sheet post-processing apparatus B includes an apparatus housing 27, the straight path 28 incorporated in the apparatus housing and including the straight path inlet 26 and the straight path discharge port 35, the processing unit B1 and the saddle unit B2, which post-process a sheet sent from the straight path 28, and the first tray 49, the second tray 61, and the third tray 71, which store a sheet sent from each post-processing unit. The apparatus housing 27 shown in FIG. 2 is arranged at substantially the same height as the housing 1 of the image forming apparatus A located on the upstream side, and on the installation surface, the discharge port 16 of the image forming apparatus A and the straight path inlet 26 of the sheet post-processing apparatus B are connected.

The housing 27 of the sheet post-processing apparatus is configured to include an apparatus frame 70. The apparatus frame 70 forms, for example, a box-shaped apparatus framework as shown in FIG. 6, and is configured to include a front-side side frame 70f located in front in the state shown in FIG. 1, a rear-side side frame 70r located on the rear surface, and a stay member (connection reinforcing member) that connects the two side frames. The straight path 28, the processing unit B1, the saddle unit B2, and the like to be described later are attached between the left and right side frames. The apparatus housing 27 is not limited to the illustrated shape, and can have a form preferable for the design, as a matter of course. The apparatus frame 70 need not always have the left and right side frames and the connecting stay structure, and various frame structures such as a monocoque structure can be employed.

### <Sheet Loading Path>

As shown in FIG. 3, the straight path 28 is formed by a substantially linear path that crosses the apparatus housing 27 in a substantially horizontal direction, and includes the straight path inlet 26 connected to the discharge port (main body discharge port) 16 of the image forming apparatus A, and the straight path discharge port 35 that is located on the opposite side of the straight path inlet 26, crossing the apparatus from the loading port (straight path inlet 26). In the straight path 28, inlet rollers 29, first conveyance rollers 201, second conveyance rollers 202, and third conveyance rollers 203 are arranged sequentially from the side of the straight path inlet 26 as a conveyance mechanism that can convey a sheet from the straight path inlet 26 to the straight path discharge port 35 and can also convey a sheet from the straight path discharge port 35 to the straight path inlet 26. Also, discharge rollers 36 (including a sheet conveyance mechanism such as a belt) are arranged as a conveyance mechanism in the straight path discharge port 35. Near the straight path inlet 26, an inlet sensor S1 that detects the leading and trailing edges of a sheet to be accepted and a lateral registration detection sensor S0 (detection unit) that detects an end face position (side end) parallel to the sheet conveyance direction are arranged. Also, near the straight path discharge port 35, a discharge sensor S2 that detects the leading and trailing edges of a sheet is arranged. The sheet discharged from the straight path discharge port 35 is discharged to the first tray 49 via a first discharge path 31 connected to the straight path discharge port 35 or guided to the processing unit B1. In the straight path 28, a punch unit 100 that punches punch holes in a sheet is arranged.

### <Layout of Sheet Loading Path>

In the straight path 28, as shown in FIGS. 2 and 3, “the saddle path 32”, “a saddle buffer path P2”, “a processing unit buffer path P1”, and “an upper conveyance path 30” are arranged in this order from the straight path inlet 26 to the straight path discharge port 35. At branch portions to the paths, a saddle path flapper 33b, a saddle buffer path flapper 33a, a processing unit buffer path flapper 200, and an upper conveyance path flapper 34 are arranged as conveyance switching mechanisms (branching mechanisms) for a conveyed sheet. In this embodiment, the saddle buffer path P2 and the upper conveyance path 30 are each formed as a retreat path for retreating a sheet. Also, as shown in FIG. 2, the saddle unit B2 is provided on one side across the straight path 28, and the saddle buffer path P2 and the upper conveyance path 30 are provided on the opposite side (other side). This can further improve the conveyance efficiency of a sheet located in the retreat path to the saddle unit B2.

In the above-described paths, the saddle path 32, the saddle buffer path P2, and the processing unit buffer path P1 are each formed as a switchback path that conveys a sheet in a direction reverse to the conveyance direction from the straight path inlet 26 to the straight path discharge port 35 and loads the sheet to each path. Also, the upper conveyance path 30 is configured to convey a sheet in the same direction as the conveyance direction from the straight path inlet 26 to the straight path discharge port 35, thereby loading the sheet.

### <Path Branching Mechanism>

The saddle path flapper 33b, the saddle buffer path flapper 33a, and the processing unit buffer path flapper 200, which are the sheet branching mechanisms, are each formed by a flapper guide capable of moving to switch the conveyance path of a sheet loaded from the straight path inlet 26, and connected to a driving mechanism (not shown) such as an electromagnetic solenoid or a mini motor. The saddle path flapper 33b guides a sheet sent from the straight path inlet 26 to the saddle path 32. The saddle buffer path flapper 33a guides a sheet sent from the straight path inlet 26 to the saddle buffer path P2. The processing unit buffer path flapper 200 guides a sheet sent from the straight path inlet 26 to the processing unit buffer path P1 via processing unit buffer rollers 301a and 301b. The upper conveyance path flapper 34 is configured to include a flapper guide capable of moving to switch the conveyance path to convey a sheet sent from the straight path inlet 26 to one of the straight path discharge port 35 and the upper conveyance path 30, and connected to a driving mechanism (not shown) such as an electromagnetic solenoid or a mini motor.

### <Upper Conveyance Path>

The upper conveyance path 30 (printout discharge path) that loads sheets other than those to be discharged to the straight path discharge port 35 is connected to the straight path 28, and the path branching portion is provided with the upper conveyance path flapper 34 configured to guide a sheet to the upper conveyance path 30. Also, the upper conveyance path 30 includes upper conveyance rollers 303 (303a and 303b) that guide a sheet to the third tray 71. The sheet guided by these to the upper conveyance path 30 is discharged from an upper conveyance path discharge port 40 to the third tray 71 (overflow tray). Note that in this embodiment, the upper conveyance path 30 is also used as a sheet retreat path.

### <Saddle Path>

The saddle path 32 configured to load a sheet to the saddle unit B2 is connected to the straight path 28, and the path branching portion is provided with the saddle path flapper 33b configured to guide the sheet to the saddle path 32. The sheet guided from the saddle path 32 to the saddle unit B2 via the saddle path discharge port undergoes saddle-stitching processing and folding processing and is then discharged to the second tray 61 via a saddle discharge path 68 in a substantially horizontal direction.

### <Saddle Buffer Path>

The saddle buffer path P2 configured to temporarily load a sheet that should undergo saddle-stitching processing and folding processing in the saddle unit B2 and make the sheet stand by is connected to the straight path 28, and the saddle buffer path flapper 33a configured to guide a sheet to the saddle buffer path P2 is formed. Also, the saddle buffer path P2 includes conveyance rollers 302 (302a and 302b) that load a sheet and make it temporarily stand by.

A fourth tray discharge port 305 is provided on the extension on the downstream side of the saddle buffer path P2 and, therefore, a sheet loaded into the saddle buffer path P2 can be discharged onto a fourth tray 310 and loaded on it. In this case, the fourth tray 310 is arranged vertically above the saddle buffer path P2. Note that the fourth tray 310 may be shared as an exterior component of the top surface of the sheet post-processing apparatus B, or may be fixed to apparatus housing. The fourth tray 310 may be configured to include a driving mechanism and be movable up/down in a substantially vertical direction.

Note that when the saddle buffer path P2 is arranged at a position to overlap vertically above the punch unit 100, the apparatus can be made more compact. However, if a space is needed to spring the punch unit 100 up to remove a sheet staying in the punch unit 100, the saddle buffer path P2 may be arranged at a position not to overlap vertically above the punch unit 100.

### <Conveyance Roller Shift Mechanism in Loading Path>

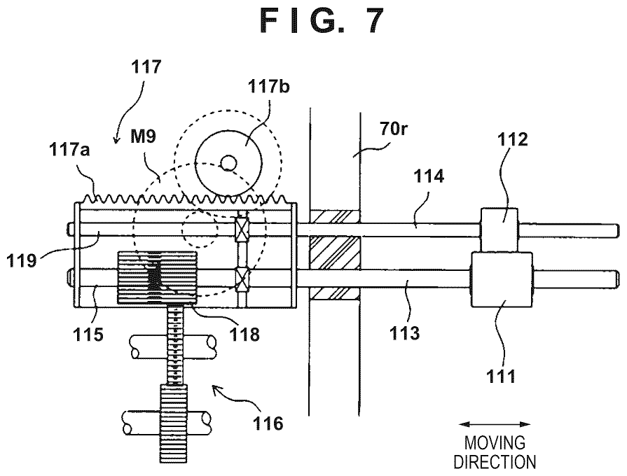

A conveyance shift mechanism of conveyance rollers on the conveyance path will be described here with reference to FIGS. 6 and 7. The first conveyance rollers 201, the second conveyance rollers 202, the third conveyance rollers 203, and the conveyance rollers 302a and 302b are configured to include driving rollers 111 and driven rollers 112, which are supported, via bearings, by the left and eight side frames 70f and 70r. A driving rotation shaft is connected to a driving roller shaft 113 via a transmission mechanism 116 (a gear transmission type is shown), and a driving motor (not shown) common to the discharge roller 36 is connected to a driving rotation shaft 115. A driven roller shaft 114 is movably supported, via bearings, by the left and right side frames 70f and 70r.

Each conveyance roller described above is rotatably attached to a shift member 117 that connects the driving roller shaft 113 and the driven roller shaft 114. By the shift member 117, the driving roller shaft 113 and the driven roller shaft 114 are connected to integrally move in the axial direction (thrust direction), and can independently rotate in the radial direction. The driving roller shaft 113 is supported, via bearings, by the left and right side frames 70f and 70r, an end portion of the driving roller shaft 113 is located in a range indicated by the axial-direction moving region of the conveyance roller on the front side of the side frame 70f, and the other end portion is located on the rear side of the side frame 70r. The shift member 117 (for example, a block member of a synthetic resin) is supported by the driving roller shaft 113 and the driven roller shaft 114 and integrally connects the two roller shafts.

A rack 117a is integrally formed on the shift member 117 and meshed with a shift motor M9 attached to the side frame 70r (the apparatus housing: the same applies hereafter) and a transmission pinion 117b. In this configuration, the shift member 117 can be moved (shift-moved) in the axial direction of the conveyance roller by the rotation of the shift motor M9 (a stepping motor capable of rotating in forward and reverse directions is shown).

A passive gear 118 is integrally formed on the driving rotation shaft 115, and the rotation of the driving motor is transmitted to the passive gear 118. In addition, a conveyance roller pair (a driving roller and a driven roller) is in pressure contact with a driven rotation shaft 119 such that it is driven and rotated by the rotation of the driving rotation shaft 115.

In this embodiment, the driving rotation shaft 115 and the driven rotation shaft 119 are connected to each other and configured such that when one of the rotation shafts moves in the axial direction, the other is driven. In addition, one of the driving roller 111 and the driven roller 112 may be attached to a rotation shaft such that it can slidably move (slide) in the axial direction, and the other roller may be moved in the axial direction such that it is linked with the movement.

### <Conveyance Shift Operation>

A shift operation (jog sorting mode) of a sheet loaded into the sheet post-processing apparatus B will be described here. A sheet sent from the image forming apparatus A is conveyed to the straight path inlet 26, the inlet rollers 29, the first conveyance rollers 201, the second conveyance rollers 202, and the third conveyance rollers 203 in this order. At this time, the transfer timing of the sheet is simultaneously detected by the inlet sensor S1. While the sheet loaded by the inlet rollers 29 passes through the straight path 28, an end position of the sheet is detected by the lateral registration detection sensor S0. The lateral registration detection sensor S0 detects how much a lateral registration error X of the sheet has occurred with respect to the center position.

If the lateral registration error X is detected by the lateral registration detection sensor S0, the rollers of the first conveyance rollers 201, the second conveyance rollers 202, and the third conveyance rollers 203 move by predetermined amounts to near and far sides while sequentially conveying the sheet, thereby performing the shift operation of the sheet (to be also referred to as “lateral registration detection processing”). After that, the sheet is distributed and conveyed to the straight path discharge port 35 or the upper conveyance path 30 by the upper conveyance path flapper 34 that is a branching mechanism, and discharged onto the first tray 49 or the third tray 71.

### <Processing Unit>

The processing unit B1 is a post-processing unit configured to include a processing tray 37 that is arranged on the downstream side of the straight path 28 and aligns and stacks a sheet sent from the straight path discharge port 35, and a binding processing mechanism that binds a stacked sheet bundle. As shown in FIG. 3, in the straight path discharge port 35 of the straight path 28, a step is formed, and the processing tray 37 is arranged under it. A first discharge path (first switchback path) 31 that reverses the conveyance direction from the discharge port and guides the sheet onto the tray is formed between the straight path discharge port 35 and the processing tray 37.

A sheet loading mechanism that loads the sheet from the discharge port onto the tray is arranged between the straight path discharge port 35 and the processing tray 37. In the processing tray 37, a positioning mechanism that positions a sheet at a predetermined binding position and a sheet bundle unloading mechanism that discharges the bound sheet bundle to the first tray 49 on the downstream side are arranged. The components will be described later.

Note that the processing tray 37 shown in FIG. 3 bridge-supports, between it and the first tray 49 on the downstream side, the sheet sent from the straight path discharge port 35. That is, the processing tray 37 is configured such that the sheet sent from the straight path discharge port 35 is bridge-supported with its leading edge portion located on the uppermost sheet on the first tray 49 on the downstream side and its trailing edge portion located on the processing tray 37.

### <Saddle Unit>

The saddle unit B2 is a post-processing unit that aligns and stacks sheets sent from the straight path 28, binds the sheets at the center portion, and fold these inward (to be referred to as “magazine finishing” hereinafter). The second tray 61 is arranged on the downstream side of the saddle unit B2 to store the sheet bundle that has undergone bookbinding processing. Note that the saddle unit may be configured to align and stack one or a plurality of sheets and only fold these inward at the center portion without performing saddle-stitching processing.

The saddle unit B2 is configured to include a guide member 66 that stacks sheets in a bundle, a leading edge regulating stopper 67 that positions a sheet at a predetermined position on the guide member 66, a staple device 63 (saddle-stitching staple unit) that saddle-stitches, at the center portion, the sheets positioned by the leading edge regulating stopper 67, and a folding processing mechanism (a folding roll pair 64 and a folding blade 65) that folds the sheet bundle at the center portion after the binding processing.

As the saddle-stitching staple unit 63, a generally known mechanism that moves, along a sheet center portion (line), a sheet bundle sandwiched between a head unit and an anvil unit and performs binding processing is employed. The folding processing mechanism is configured such that, as shown in FIG. 2, the crease of the sheet bundle is inserted, by the folding blade 65, between the rolls of the folding roll pair 64, which are in pressure contact with each other, and the sheet bundle is folded by rolling of the roll pair.

The processing unit B1 and the straight path 28 shown in FIG. 2 are arranged in a substantially horizontal direction, the saddle path 32 that guides a sheet to the saddle unit B2 is arranged in the vertical direction, and the guide member 66 that aligns and stacks a sheet is arranged in a substantially vertical direction. When the straight path 28 is arranged in a direction of crossing the apparatus housing 27, and the saddle path 32 and the saddle unit B2 are arranged in the vertical direction, the apparatus can be made slim.

The second tray 61 is arranged on the downstream side of the saddle unit B2, and a sheet bundle folded like a magazine can be stored. The second tray 61 is arranged on the lower side of the first tray 49. This is because the use frequency of the first tray 49 is assumed to be higher than the use frequency of the second tray 61, and the position of the first tray 49 is set as a height to easily extract a sheet on the tray.

### <Punch Unit>

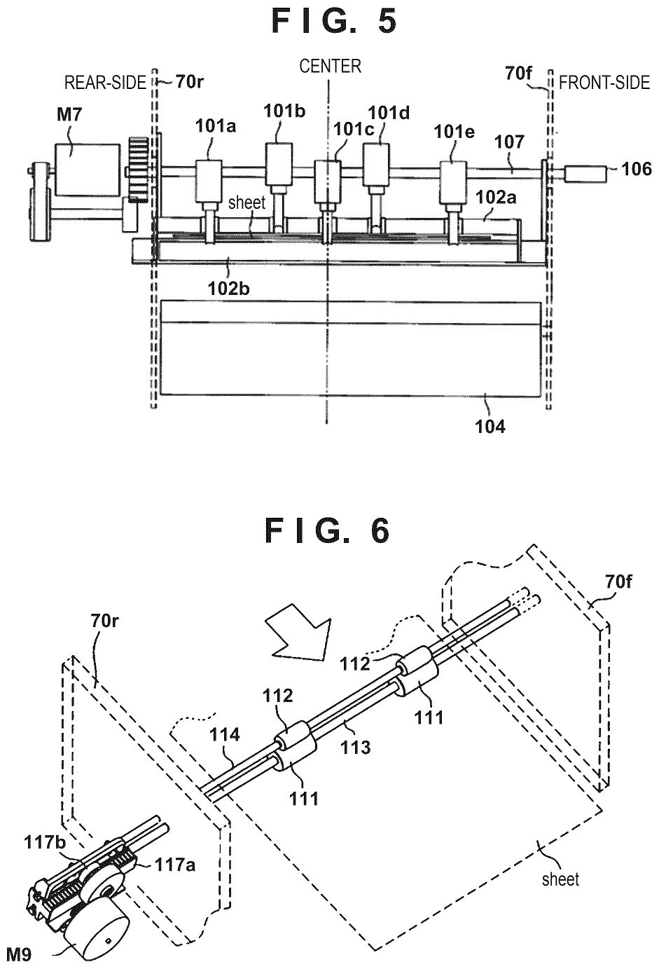

The punch unit 100 that is arranged in the straight path 28 and punches punch holes in a sheet sent from the straight path inlet 26 will be described with reference to FIG. 5. In the punch unit 100, a plurality of punch members 101a to 101e are arrayed at a predetermined interval in a direction orthogonal to the sheet conveyance direction of the straight path 28, and a selected number of holes are punched in a sheet.

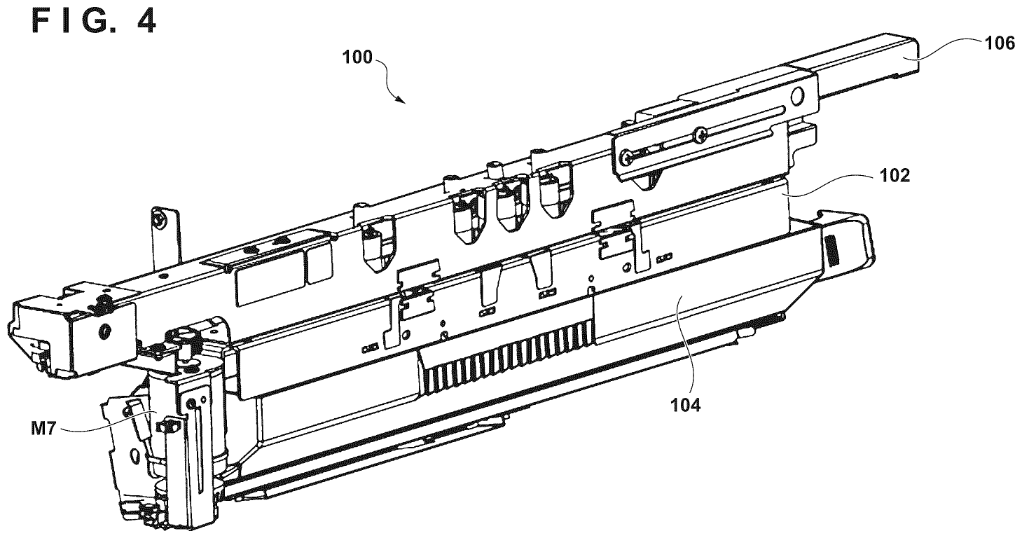

FIG. 4 shows the overall configuration of the punch unit 100. The punch unit 100 is configured to include a unit frame 102, the plurality of punch members 101a to 101e arrayed in the unit frame 102 to be movable in the vertical direction, a drive cam that moves each punch member in the vertical direction (reciprocally moves each punch member in the punch direction), and a driving motor M7 that drives the drive cam.

Reference numeral 104 in FIG. 4 denotes a waste box that is arranged under punch members 101 and stores punching chips. The waste box 104 is attached to a guide rail (not shown) such that it can slide with respect to the apparatus frame 70 (different from the unit frame). Reference numeral 106 denotes a rotation operation member that forcibly rotates the drive cam to separate (peel off) the punch member 101 bitten into a sheet in a case of jam in the punch member 101 or an abnormality in the driving motor M7. Hence, the rotation operation member 106 is formed by a manual rotary knob connected to a rotation shaft 107 of the drive cam.

As shown in FIG. 5, the unit frame 102 is configured to include an upper frame 102a and a lower frame 102b, each of which has a predetermined length in a direction orthogonal to the sheet conveyance direction of the straight path 28. In the upper frame 102a, the plurality of punch members 101a to 101e are arranged at a predetermined interval in a direction (to be referred to as a “conveyance orthogonal direction” hereinafter) orthogonal to the sheet conveyance direction such that these can reciprocally move (vertically move) in a punching direction. In the lower frame 102b, punching holes (dies) are formed at positions facing the punch members 101. In addition, the driving rotation shaft 107 is arranged in the unit frame 102, and the drive cam that moves the punch members 101 in the vertical direction is attached to the driving rotation shaft 107. The driving motor M7 is connected to the driving rotation shaft 107 via a transmission mechanism.

The drive cam is formed by a cylindrical cam member pivotally attached to the driving rotation shaft 107 and corresponding to the plurality of punch members 101, and each punch member is connected to the cam member via a connecting pin. When the driving rotation shaft 107 rotates by a predetermined angle, the punch members 101 vertically move in the punching direction. At this time, the punch members 101b and 101d of a first group (for example, two-hole punching) in the plurality of punch members vertically move in the punching direction at a first rotation angle of the driving rotation shaft 107. At a different second rotation angle, the punch members 101a, 101c, and 101e of a second group (for example, three-hole punching) vertically move in the punching direction.

Hence, when the driving rotation shaft 107 is reciprocally rotated within a preset angle range under the control of the motor M7, a binding processing control unit 95 to be described later causes the punch members 101b and 101d of the first group to make a punching motion. When the driving rotation shaft 107 is reciprocally moved within a different angle range, the punch members 101a, 101c, and 101e of the second group can be caused to make a punching motion.

The waste box 104 is arranged under the punch members 101 and supported by a guide rail (not shown) provided in the apparatus frame, and can be detached from the apparatus front side.

The driving motor M7 is connected to the driving rotation shaft 107 via a deceleration mechanism (gear transmission mechanism). To allow an operator to manually make rotation, a rotation member is inserted to a hole provided in the side frame 70f and arranged on the front side of the side frame 70f. A front cover is openably and closably arranged on the apparatus front side, and in an open state, the rotation operation member 106 can be operated. Note that in the cover open state, the driving power to the driving motor M7 is not supplied (blocked).

### Configuration of Processing Unit

The configurations of the sheet loading mechanism, the sheet positioning mechanism, the binding processing mechanism, and the sheet bundle unloading mechanism of the processing unit B1 will be described next.

### <Sheet Loading Mechanism>

As shown in FIG. 3, a reversing conveyance mechanism that switchback-conveys a sheet from the straight path discharge port 35 in a discharge direction and a discharge opposing direction, a guide mechanism (sheet guide member) 44 that guides the sheet to the tray side, and a raking rotation body 46 that guides the sheet to a trailing edge regulating portion are arranged between the straight path discharge port 35 and the processing tray 37.

The reversing conveyance mechanism is configured to include an elevating roller 41 that vertically moves between an operating position at which it engages with a sheet loaded onto the processing tray 37 and a standby position at which it is apart from the sheet, and a paddle rotation body 42 that transfers the sheet to the discharge opposing direction, and the elevating roller 41 and the paddle rotation body 42 are attached to a swing bracket 43.

In the apparatus housing 27, the swing bracket 43 is arranged to be able to swing about a rotation shaft (for example, a discharge roller shaft). The rotation shafts of the elevating roller 41 and the paddle rotation body 42 are supported by the swing bracket 43 via bearings. An elevating motor (not shown) is connected to the swing bracket 43, and the swing bracket 43 vertically moves the elevating roller 41 and the paddle rotation body 42, which are mounted thereon, between the operating position at which the elevating roller 41 engages with a sheet and the standby position at which it is apart from the sheet.

Also, a driving motor (not shown) is connected to the elevating roller 41 and the paddle rotation body 42 to transmit driving such that the elevating roller 41 rotates in forward and reverse directions, and the paddle rotation body 42 rotates in the reversing direction (discharge opposing direction). A driven roller 48 that is in pressure contact with the elevating roller 41 is arranged in the processing tray 37 to nip a single sheet or a bundle of sheets and discharge it to the downstream side.

A guide mechanism that guides the trailing edge of a sheet loaded onto the processing tray 37 toward a sheet end regulating portion 38 is arranged between the elevating roller 41 and the raking rotation body 46 to be described later. The guide mechanism is configured to include the sheet guide member 44 that vertically moves from a dotted line state to a solid line state in FIG. 3. The sheet guide member 44 retreats to the dotted line position when a sheet is discharged from the straight path discharge port 35, and after the sheet trailing edge passes through the straight path discharge port 35, guides the sheet trailing edge onto the processing tray 37. To do this, a driving mechanism (not shown) is connected to the sheet guide member 44, and the sheet guide member 44 vertically moves in accordance with the timing of guiding the sheet trailing edge from the straight path discharge port 35 onto the processing tray 37.

### <Sheet Positioning Mechanism>

Positioning mechanisms 38 and 39 that position a sheet at a predetermined binding position are arranged on the processing tray 37, and those shown in FIG. 3 are configured to include the sheet end regulating portion 38 that regulates a sheet trailing edge by abutment, and the side edge alignment portion 39 that positions a sheet side edge to a reference position (center reference or one side reference).

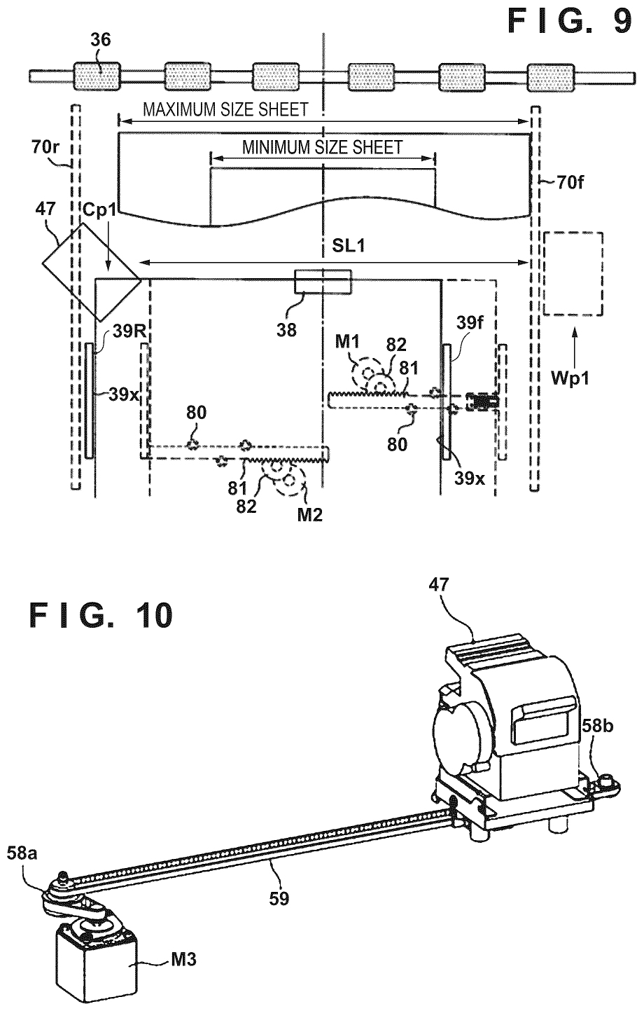

As shown in FIG. 3, the sheet end regulating portion 38 is formed by a stopper member that regulates a sheet trailing edge by abutment. As for the side edge alignment member 39, as will be described later with reference to FIG. 9, a sheet is discharged from the straight path 28 with the center reference, and positioning with the same center reference or positioning with the one side reference is executed in accordance with the type of the binding mode.

### <Side Edge Alignment Mechanism>

As shown in FIG. 9, side edge alignment plates 39F and 39R project upward from a sheet placement surface 37a of the processing tray 37, have regulating surfaces 39x that engage with the side edges of a sheet, and are arranged as a pair of left and right parts facing each other. The pair of side edge alignment portions 39 is arranged on the processing tray 37 such that these can reciprocally move at a predetermined stroke. The stroke is set based on the size difference between a maximum size sheet and a minimum size sheet and an offset amount to move (offset-convey) a sheet bundle after alignment in one of left and right directions.

That is, the moving stroke of the left and right side edge alignment plates 39F and 39R is set based on the moving amount to align a different size sheet and the offset amount of a sheet bundle after alignment. Note that in corner binding, the side edge alignment plates 39F and 39R move a sheet unloaded with the center reference, by a predetermined amount, to the right side in a case of right corner binding or to the left side in a case of left corner binding (offset movement). The offset movement is executed every time a sheet is loaded to the processing tray 37 (for each loaded sheet), or executed to move a bundle to perform binding processing after sheets are aligned into the bundle.

Hence, as shown in FIG. 9, the side edge alignment portions 39 are configured to include the right side edge alignment member 39F (apparatus front side) and the left side edge alignment member 39R (apparatus rear side). For the two side edge alignment members, the regulating surfaces 39x that engage with sheet side edges are supported on the processing tray 37 such that these move in approaching directions or separating directions. Slit grooves (not shown) extending through the processing tray from the upper surface to the lower surface are provided in the processing tray 37. The side edge alignment portions 39 with the regulating surfaces 39x that engage with sheet side edges are slidably fitted in the slit grooves.

The side edge alignment plates 39F and 39R are slidably supported by a plurality of guide rolls 80 on the tray rear surface, and racks 81 are integrally formed. Alignment motors M1 and M2 are connected to the left and right racks 81 via pinions 82. The left and right alignment motors M1 and M2 are each formed by a stepping motor, and are configured to detect the positions of the left and right side edge alignment plates 39F and 39R by position sensors (not shown) and, based on detection values, move the alignment members in both left and right directions by a designated moving amount. Note that the configuration is not limited to the rack-and-pinion mechanism shown in FIG. 9, and the side edge alignment plates 39F and 39R may be fixed to a timing belt, and the timing belt may be connected, by a pulley, to a motor that reciprocally moves the timing belt in the left and right directions.

In the above-described configuration, the binding processing control unit 95 to be described later makes the left and right side edge alignment plates 39F and 39R stand by at predetermined standby positions (width size of sheet+α position) based on sheet size information provided from the image forming apparatus A. In “multi-binding”, a sheet is loaded onto the processing tray 37, and an alignment operation is started at a timing when a sheet end abuts against the sheet end regulating portion 38. The alignment operation is performed by rotating the left and right alignment motors M1 and M2 by the same amount in opposite directions (approaching directions). Then, the sheet loaded onto the processing tray 37 is positioned based on the sheet center as the reference, and stacked into a bundle. The sheet loading operation and the alignment operation are repeated, thereby aligning and stacking sheets in a bundle on the processing tray 37. At this time, sheets of different sizes are positioned with the center reference. In “corner binding”, a sheet is loaded onto the processing tray 37, and an alignment operation is started at a timing when a sheet end abuts against the sheet end regulating portion 38. The alignment operation is performed by setting different moving amounts for the alignment plate on the binding position side and the alignment plate on the opposite side of the binding position. The moving amounts are set such that a sheet corner is located at a preset binding position.

### <Binding Processing Mechanism>

On the processing tray 37, a binding processing mechanism 47 that binds a sheet bundle stacked on the sheet placement surface 37a is arranged. The sheet placement surface 37a of the processing tray 37 is positioned to a predetermined binding position by a positioning mechanism (the sheet end regulating portion 38 and the side edge alignment portion 39). The binding processing mechanism 47 is formed as a binding unit 47 (“staple unit”: the same applies hereafter) that needle-binds a sheet bundle using staple needles.

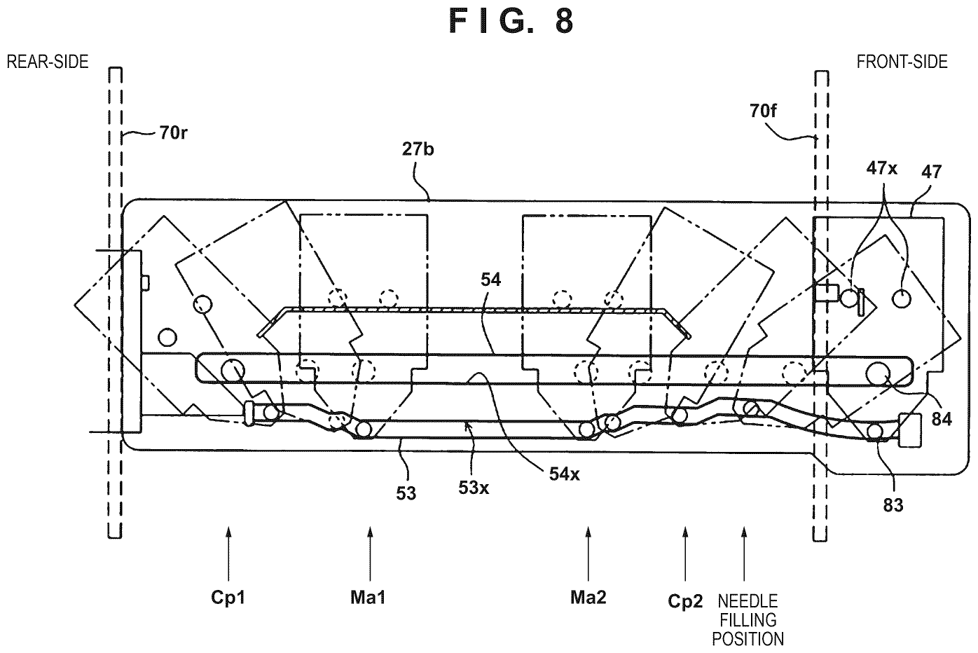

On the processing tray 37, the binding processing mechanism 47 that binds the trailing edge of a sheet loaded from the straight path discharge port 35 is arranged. As shown in FIG. 8, the binding processing mechanism 47 is formed by the staple unit 47 capable of moving along the rear end portion of the sheet placement surface 37a of the processing tray 37.

FIGS. 8 and 9 show the staple unit 47 arranged on the processing tray 37. In FIG. 9, a binding position Cp1 is set at a sheet corner located on the left side. The staple unit 47 moves at a predetermined stroke SL1 along a first traveling rail 53 and a second traveling rail 54 formed on an apparatus frame 27b.

FIG. 9 shows the sheet loaded onto the processing tray 37 and the moving stroke SL1 of the binding unit 47. To the processing tray 37, sheets of different sizes including a maximum size sheet to a minimum size sheet are loaded with the center reference. The sheets are aligned by the pair of left and right side edge alignment plates 39F and 39R with respect to the binding side edge (the left side edge in FIG. 9) of the sheets as the reference such that the sheets of different sizes match. To do this, the left and right side edge alignment plates 39F and 39R are connected to the different driving motors M1 and M2, and the binding processing control unit 95 to be described later sets the moving amounts of the left and right side edge alignment plates 39F and 39R in accordance with the sheet sizes.

Note that in binding processing other than binding processing of binding the sheet corner, for example, in a multi-binding mode to be described later, the binding processing control unit 95 to be described later aligns a sheet with the center reference. In this case, the left and right side edge alignment plates 39F and 39R move from the standby positions toward the sheet center by the same amount, thereby positioning the sheet to the binding position.

This will be described with reference to FIG. 9. The binding unit 47 moves at the stroke SL1 between a standby position Wp1 (first standby position) and the binding position Cp1. That is, the binding unit 47 reciprocally moves between the standby position Wp1 and the binding position Cp1 along the traveling rails 53 and 54 (guide grooves or guide rods). The first standby position Wp1 is set outside the maximum size sheet to be bound on the processing tray 37.

FIG. 10 shows the configuration of the binding unit 47. On the apparatus frame 27b, a pair of left and right pulleys 58a and 58b are arranged along the moving region (the left-and-right direction in FIG. 9) of the staple unit 47. A timing belt 59 (toothed belt) is stretched between the pulleys, and a driving motor M3 (stepping motor) is connected to one pulley 58a.

### <Staple Moving Mechanism>

As shown in FIG. 8, the staple unit 47 is mounted on the apparatus frame (chassis frame) 27b fixed to the side frames 70f and 70r through an opening portion provided in the side frame 70f of the apparatus frame 70, so that it can move at a predetermined stroke. The first traveling rail 53 and the second traveling rail 54 are arranged on the apparatus frame 27b. A traveling rail surface 53x is formed on the first traveling rail 53, and a traveling cam surface 54x is formed on the second traveling rail 54. The traveling rail surface 53x and the traveling cam surface 54x cooperatively support the staple unit 47 (to be referred to as the “moving unit” hereinafter) such that the staple unit 47 can reciprocally move at the predetermined stroke, and simultaneously control the angular posture.

On the first traveling rail 53 and the second traveling rail 54, the rail surface 53x and the traveling cam surface 54x are formed such that the moving unit reciprocally moves in its moving range. As shown in FIG. 10, the timing belt 59 connected to the driving motor (traveling motor) M3 is fixed to the staple unit 47. The timing belt 59 is wound on the pair of pulleys 58a and 58b axially supported on the apparatus frame 27b, and the driving motor M3 is connected to one of the pulleys. Hence, when the driving motor M3 rotates in the forward and reverse directions, the staple unit 47 reciprocally moves at the stroke SL1.

The staple unit 47 engages with the first traveling rail 53 and the second traveling rail 54 in the following way. As shown in FIG. 8, the staple unit 47 is provided with a first rolling roller 83 (rail fitting member) that engages with the traveling rail surface 53x and a second rolling roller 84 (cam follower member) that engages with the traveling cam surface 54x. Also, sliding rollers 47x (two sliding rollers in FIG. 8) that have a ball shape and engage with the support surface of the frame 27b are formed on the staple unit 47. In addition, a guide roller 47y that engages with the bottom surface of a bottom frame is formed on the staple unit 47, thereby preventing the staple unit 47 from floating from the apparatus frame 27b.

With the above-described configuration, the staple unit 47 is supported on the apparatus frame 27b such that is can be moved by the sliding roller 47x and the guide roller 47y. Also, the first rolling roller 83 and the second rolling roller 84 travel in accordance with the rail surface 53x and the cam surface 54x, respectively, while rotating along the traveling rail surface 53x and the traveling cam surface 54x.

### <Stack Tray Elevating Mechanism>

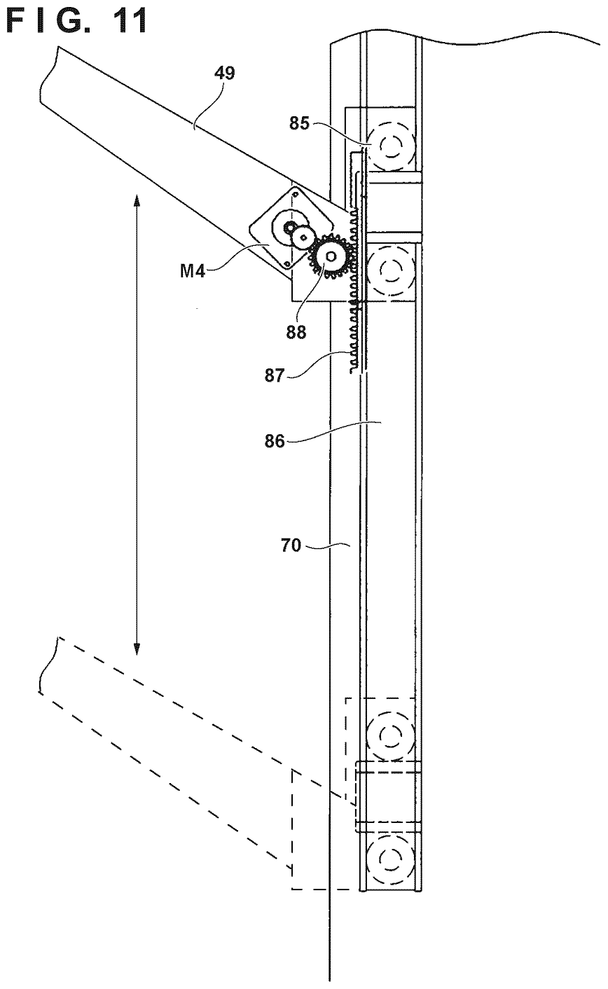

As shown in FIG. 11, the sheet post-processing apparatus B includes the first tray 49. The first tray 49 is configured to move up and down in accordance with the load amount of sheets. For this purpose, guide rollers 85 are provided at two points on the upper and lower sides at the proximal end portion of the first tray 49, and the guide rollers 85 are fitted and supported in an elevating guide 86 provided in the apparatus housing 27. An elevating gear 88 is provided at the proximal end portion of the first tray 49 and connected to an elevating rack gear 87. Also, an elevating motor M4 is connected to the elevating gear 88. Hence, the first tray 49 is moved up and down in accordance with the load amount of sheets by controlling rotation of the elevating motor M4.

### <Sheet Bundle Unloading Mechanism>

A sheet bundle unloading mechanism that unloads a sheet bundle that has undergone binding processing to the first tray 49 on the downstream side is arranged on the processing tray 37. As a configuration for conveying a sheet bundle to the downstream side, a method (unloading roller mechanism) of conveying a sheet bundle by rollers in pressure contact with each other and a conveyor mechanism that extrudes a sheet trailing edge by an extruding member that moves along the tray surface from the upstream side to the downstream side are known. The apparatus shown in the drawings employs both methods.

FIGS. 12A to 12C show the sheet bundle unloading mechanism. The conveyor mechanism is configured to include an extruding projection 45 that transfers a sheet bundle, along the processing tray 37, from the binding position (processing position) located on the upstream side to the stack tray (first tray) 49 on the downstream side, a conveyor belt 45v that moves the extruding projection, and a driving motor M6. On the processing tray 37, the driven roller 48 is arranged at the loading port (the boundary between the sheet placement surface 37a and the first tray 49), and the elevating roller 41 in pressure contact with the driven roller 48 is arranged to face the driven roller 48. An unloading roller mechanism is formed by the driven roller 48 and the elevating roller 41.

Hence, the conveyor mechanisms 45 and 45v that transfer the sheet bundle by extruding it from the upstream side to the downstream side and the unloading roller mechanisms 48 and 41 that nip the sheet bundle and unload it are arranged on the processing tray 37. FIG. 12A shows a state in which the sheet bundle is located at the binding position on the processing tray 37. At this time, the conveyor mechanisms 45 and 45v and the unloading roller mechanisms 48 and 41 are set in an operating state. FIG. 12B shows a state halfway through transfer of the sheet bundle from the processing position to the downstream side. The sheet bundle is sent to the downstream side by movement of the extruding projection 45 and rotation of the unloading roller mechanisms 48 and 41. FIG. 12C shows a state immediately before unloading of the sheet bundle to the first tray 49 on the downstream side. On the processing tray, the sheet bundle is sent to the downstream side gradually (at a low speed) by rotation of the unloading roller mechanisms 48 and 41. At this time, the extruding projection 45 stands by at the position shown in FIG. 12C and returns (retreats) to the initial position.

### <Configuration of Staple Unit>

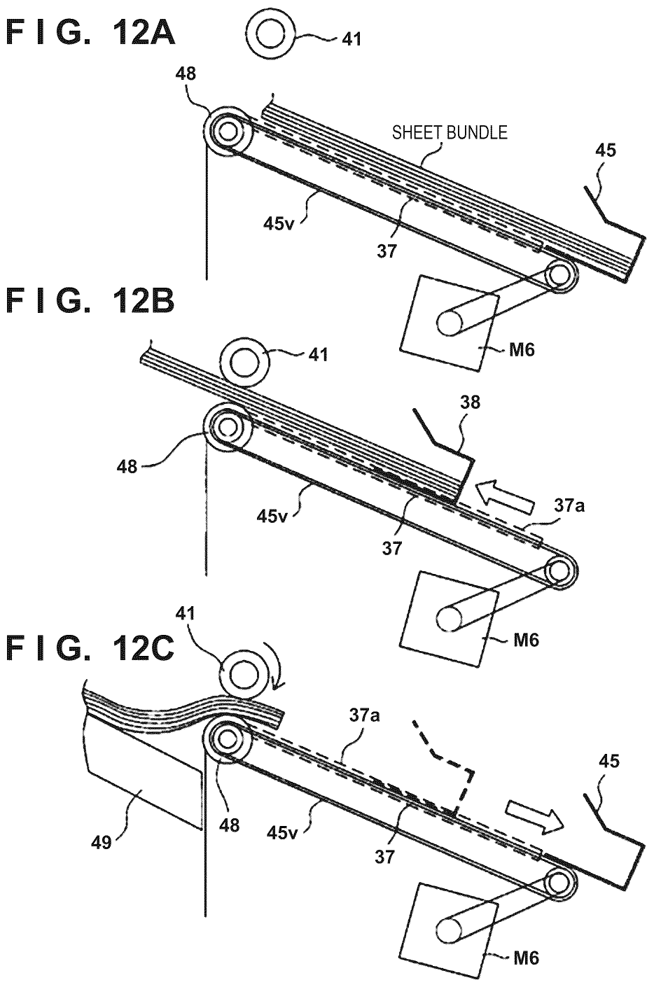

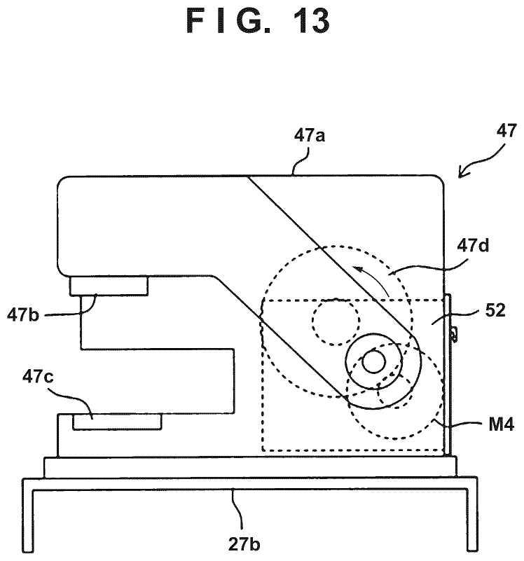

The configuration of the above-described staple unit will be described with reference to FIG. 13. The staple unit 47 is formed as a unit separately from the sheet post-processing apparatus B. A unit frame 47a having a box shape, a drive cam 47d swingably axially supported on the unit frame 47a, and the driving motor M4 that makes the drive cam 47d pivot are mounted in the unit frame 47a.

In the drive cam 47d, a staple head 47b and an anvil member 47c are arranged at the binding position to face each other. The staple head 47b is biased by a biasing spring (not shown) of the drive cam 47d from the standby position on the upper side to the staple position (anvil member) on the lower side and vertically moves. A needle cartridge 52 is detachably attached to the unit frame 47a.

The needle cartridge 52 stores linear blank needles, and the needles are supplied to the staple head 47b by a needle feed mechanism. The staple head portion 47b incorporates a former member that bends a linear needle into a U shape, and a driver that presses a bent needle into a sheet bundle. With this configuration, the drive cam 47d is rotated by the driving motor M4 to energize the biasing spring. When the rotation angle reaches a predetermined angle, the staple head portion 47b moves down to the side of the anvil member 47c with great force. By this operation, a staple needle is bent into a U shape and then inserted into the sheet bundle by the driver. The tips of the needle are bent by the anvil member 47c, thereby performing staple binding.

The needle feed mechanism is incorporated between the needle cartridge 52 and the staple head 47b, and a sensor (empty sensor) that detects absence of needles is arranged in the needle feed mechanism. Also, a cartridge sensor (not shown) that detects whether the needle cartridge 52 is inserted or not is arranged in the unit frame 47a.

The needle cartridge 52 employs a structure in which layers of staple needles connected in a band are stacked and stored in a cartridge having a box shape, and a structure in which staple needles are stored in a roll shape. The unit frame 47a is provided with a circuit that controls the above-described sensors, and a circuit board that controls the driving motor M4, and is configured to generate an alarm signal when the needle cartridge 52 is not stored or stable needles are absent. The staple control circuit is configured to control the driving motor M4 to execute the staple operation by a staple needle signal, and generate an “operation end signal” when the staple head portion 47b moves from the standby position to the staple position and returns to the standby position again.

### <Explanation of Control Configuration>

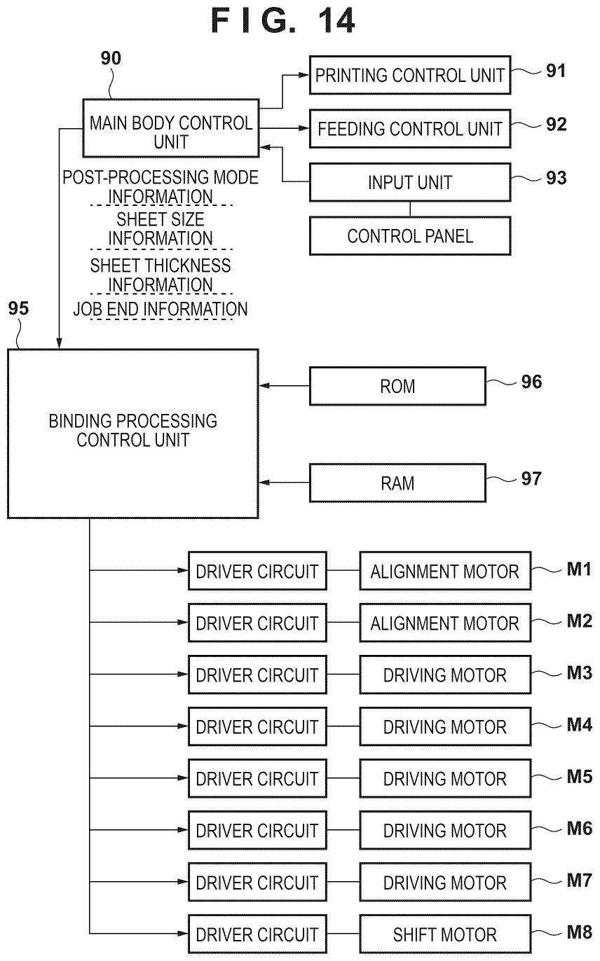

A control configuration in the image forming system shown in FIG. 1 will be described with reference to FIG. 14. The image forming system shown in FIG. 14 includes the control unit 90 (to be referred to as the “main body control unit” hereinafter) of the image forming apparatus A, and the control unit 95 (to be referred to as the “binding processing control unit” hereinafter) of the sheet post-processing apparatus B. The main body control unit 90 controls a printing control unit 91, a feeding control unit 92, and an input unit 93 (control panel).

“Image forming mode” and “post-processing mode” are set based on a user operation accepted via the input unit 93 (control panel). In the image forming mode, for example, a mode such as color/monochrome printing or doubles-sided/single-sided printing is set, and image forming conditions such as a sheet size, sheet quality, the number of printout copies, and resizing printing are set. Also, in the “post-processing mode”, for example, “printout mode”, “bookbinding processing discharge mode”, “staple binding processing mode”, or “jog sorting mode” is set.

Also, the main body control unit 90 transfers, to the binding processing control unit 95, data indicating that the mode is the post-processing mode and data indicating the number of sheets, copy count information, and sheet thickness information of sheets to form images. At the same time, the main body control unit 90 transfers a job end signal to the binding processing control unit 95 every time image formation is ended.

The post-processing mode will be described. The “printout mode” is a mode in which sheets from the straight path discharge port 35 are stored in the stack tray 49 via the processing tray 37 without binding processing. In this case, the sheets are stacked on the processing tray 37 in an overlapped state, and a sheet bundle after stacking is unloaded to the stack tray 49 in accordance with the job end signal from the main body control unit 90.

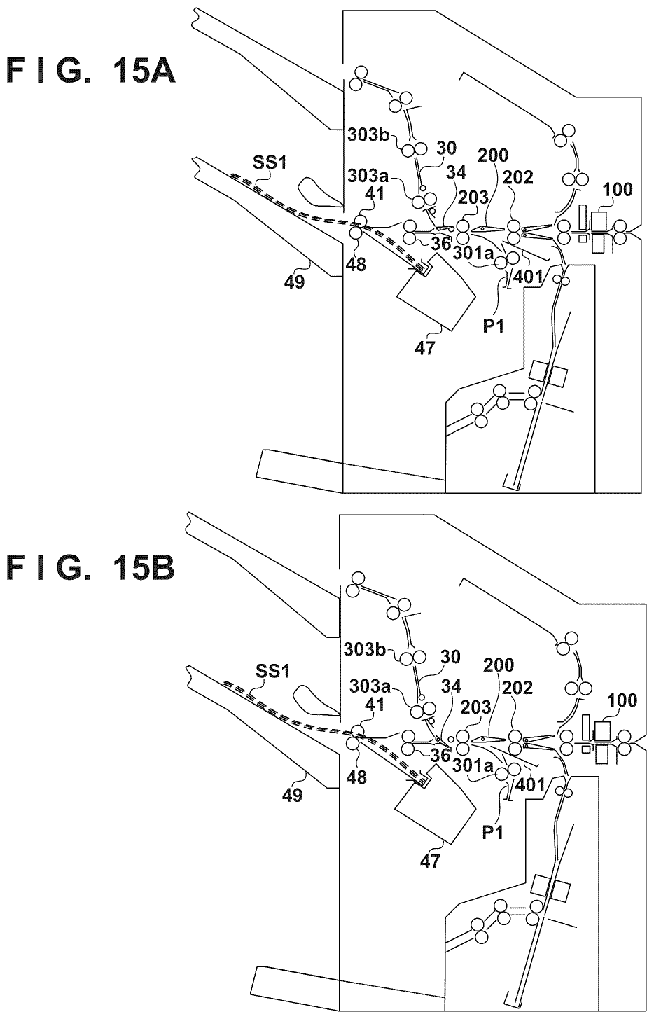

The “bookbinding processing discharge mode” is a mode in which sheets with images formed thereon are aligned and bound and then folded to do bookbinding-finishing. Details will be described with reference to FIG. 15.

The “staple binding processing mode” is a mode in which sheets from the straight path discharge port 35 are stacked and aligned on the processing tray 37, and the sheet bundle is bound and then stored in the stack tray 49. In this case, an operator designates such that the sheets to form images have the same sheet thickness and the same size. In the staple binding processing mode, one of “multi-binding”, “right corner binding” and “left corner binding” is selected and designated.

In the “jog sorting mode”, sheets with images formed by the image forming apparatus A are divided into a group to be offset-moved and stacked and a group to be stacked without being offset-moved. Sheet bundles that are offset-moved and sheet bundles that are not offset-moved are alternately stacked on the stack tray.

### <Binding Processing Control Unit>

The binding processing control unit 95 causes the sheet post-processing apparatus B to operate in accordance with the post-processing mode set by the main body control unit 90. The binding processing control unit 95 is configured to include a control CPU. A ROM 96 and a RAM 97 are connected to the binding processing control unit 95, and the operation of the sheet post-processing apparatus B according to this embodiment is executed based on a control program stored in the ROM 96 and control data stored in the RAM 97. Hence, the binding processing control unit 95 controls the driver circuits of all the driving motors described above, thereby starting/stopping the motors and controlling forward/reverse rotations.

Even during post-processing in the processing unit B1, image formation is continuously performed by the image forming apparatus A. In this embodiment, a buffer operation of accumulating, in the sheet post-processing apparatus B, sheets conveyed from the image forming apparatus A is performed. This makes it possible to continuously perform post-processing without lowering the frequency of supplying sheets from the image forming apparatus A, that is, without lowering productivity of the image forming apparatus A.

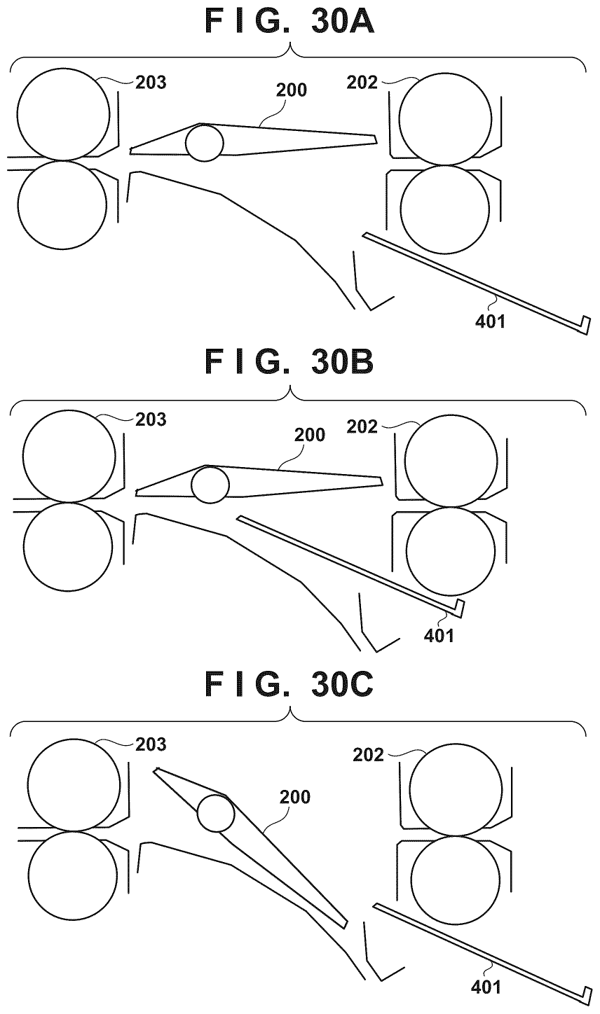

The outline of the sheet buffer operation in the sheet post-processing apparatus B will be described with reference to FIGS. 15A to 30C. FIGS. 15A to 29 are sectional views showing the sheet post-processing apparatus B viewed from a side surface direction. FIGS. 30A to 30C are views showing a configuration on the periphery of the processing unit buffer path flapper 200. A buffer operation of a subsequent sheet in a case where a preceding sheet bundle exists on the processing tray 37 of the staple unit 47 will be described below. For example, the binding processing control unit 95 acquires information of the sensor provided in the binding unit 47, and upon detecting that a preceding sheet bundle exists, performs following processing.

In FIG. 15A, a sheet bundle SS1 indicates a preceding sheet bundle, and binding processing is performed by the binding unit 47. Note that in this example, the number of sheets of the sheet bundle to be subjected to binding processing by the binding unit 47 is three. Note that the number of sheets of the sheet bundle is not limited to three, and may be less or more than three. In FIG. 15A, the upper conveyance path flapper 34 is opened upward, and a sheet conveyed on the straight path 28 is thus conveyed in the direction of the elevating roller 41 and the driven roller 48. At this time, a sheet support 401 is located at a standby position to be described later, and the processing unit buffer path flapper 200 can pivot downward. Also, during binding processing by the binding unit 47, the elevating roller 41 and the driven roller 48 nip to suppress deviation of the bundle.

Possible positions of the sheet support 401 will be described here. FIGS. 30A to 30C are enlarged views of the periphery of the processing unit buffer path flapper 200 and the sheet support 401. The processing unit buffer path flapper 200 provided between the second conveyance rollers 202 and the third conveyance rollers 203 is configured to pivot downward in FIGS. 30A to 30C.

FIG. 30A shows a state in which the processing unit buffer path flapper 200 is opened upward, and the sheet support 401 is located on the lower side of the second conveyance rollers 202. In this embodiment, the position of the sheet support 401 at this time is called a standby position. In the state shown in FIG. 30A, the processing unit buffer path flapper 200 can pivot downward.

FIG. 30B shows a state in which the processing unit buffer path flapper 200 is opened upward, and the sheet support 401 moves to the side of the processing unit buffer path flapper 200. In this embodiment, the position of the sheet support 401 at this time is called a support position. When the sheet support 401 is located at the support position, the sheet conveyed from the side of the second conveyance rollers 202 can be supported from the lower side. This configuration can prevent the leading edge of the sheet from hanging down to cause jam or the like.

FIG. 30C shows a state in which the sheet support 401 is located at the standby position, and the processing unit buffer path flapper 200 has pivoted downward. Since the processing unit buffer path flapper 200 has pivoted downward, the sheet conveyed from the side of the third conveyance rollers 203 can be guided to the processing unit buffer path P1.

For example, in the sheet post-processing apparatus B, an operation of making a sheet conveyed from the side of the second conveyance rollers 202 pass through the third conveyance rollers 203 causing the processing unit buffer path flapper 200 to pivot downward at the timing when the trailing edge of the sheet passes through the second conveyance rollers 202, reversing the conveyance direction of the sheet, and guiding and conveying it to the processing unit buffer path P1 (reversing conveyance) is performed. To quickly perform the operation, the arm length of the processing unit buffer path flapper 200 is formed long. On the other hand, when the pivot space of the processing unit buffer path flapper 200 is large, the interval between the second conveyance rollers 202 and the third conveyance rollers 203 is large. As a result, the leading edge of the sheet conveyed from the side of the second conveyance rollers 202 may hang down to cause jam or the like. In this embodiment, when conveying a sheet on the straight path 28 formed by the second conveyance rollers 202 and the third conveyance rollers 203, the sheet support 401 is moved to the support position, as shown in FIG. 30B. This can prevent the above-described situation.

In FIG. 15B, the upper conveyance path flapper 34 changes from a state in which it is opened upward to a state in which it is opened downward. The sheet conveyed on the straight path 28 is thus conveyed to the upper conveyance path 30. In addition, the sheet support 401 moves to the support position. The sheet conveyed on the straight path 28 is thus supported from the lower side by the sheet support 401.

The upper conveyance path 30 aims at preventing the subsequent sheet to be buffered from projecting to the side of the elevating roller 41 and the driven roller 48 at the time of buffering. The subsequent sheet is conveyed at various timings. If a sheet exists on the processing tray 37 of the binding unit 47, the elevating roller 41 and the driven roller 48 may nip and stop, or may nip and discharge a bundle at a low speed. At this timing, the subsequent sheet that is longer than a predetermined length and conveyed at a speed higher than the bundle discharge speed is blocked at the nip position between the elevating roller 41 and the driven roller 48 of the binding unit 47 and cannot be conveyed to the position where it can be buffered. For this reason, the subsequent sheet that is longer than the predetermined length is temporarily sent to the upper conveyance path 30 to perform the buffer operation without making the subsequent sheet that is longer than the predetermined length projecting to the side of the elevating roller 41 and the driven roller 48.

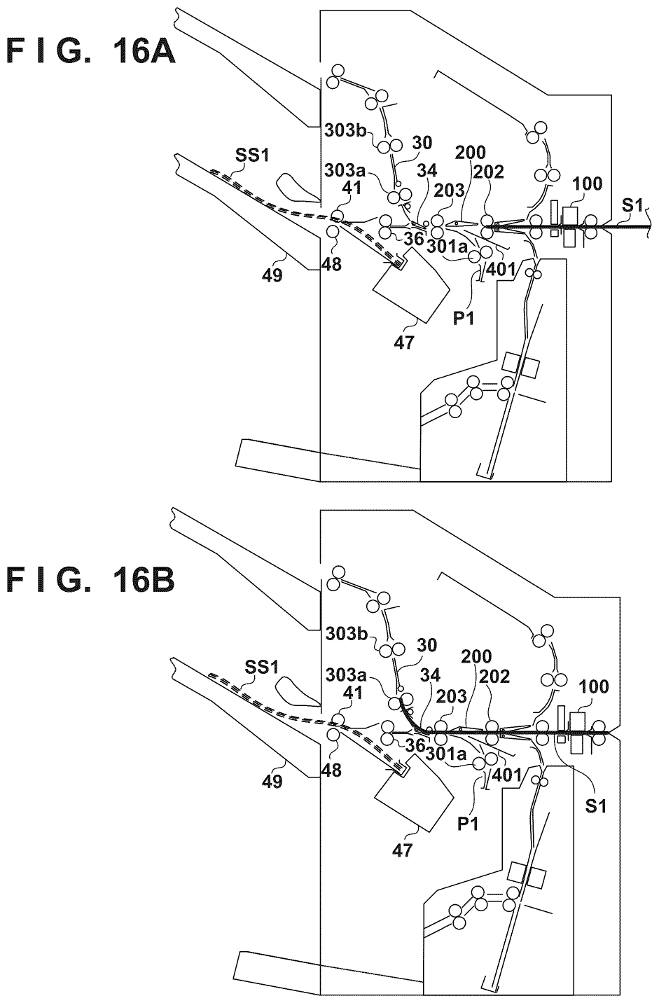

FIG. 16A shows a state in which a sheet S1 is sent from the image forming apparatus A. The sheet S1 is the first sheet of a sheet bundle to be processed by the binding unit 47 at the subsequent stage. FIG. 16A shows a state in which the sheet S1 is conveyed up to the second conveyance rollers 202. As described above, since the sheet support 401 moves to the support position, it is possible to prevent the leading edge of the sheet S1 from hanging down to cause jam or the like.

FIG. 16B shows a state in which the sheet S1 is conveyed up to the upper conveyance rollers 303a. At the timing from the binding processing of the preceding sheet bundle SS1 in the binding unit 47 to just before bundle discharge, the sheet subsequently sent from the image forming apparatus A can be retreated to the upper conveyance path 30.

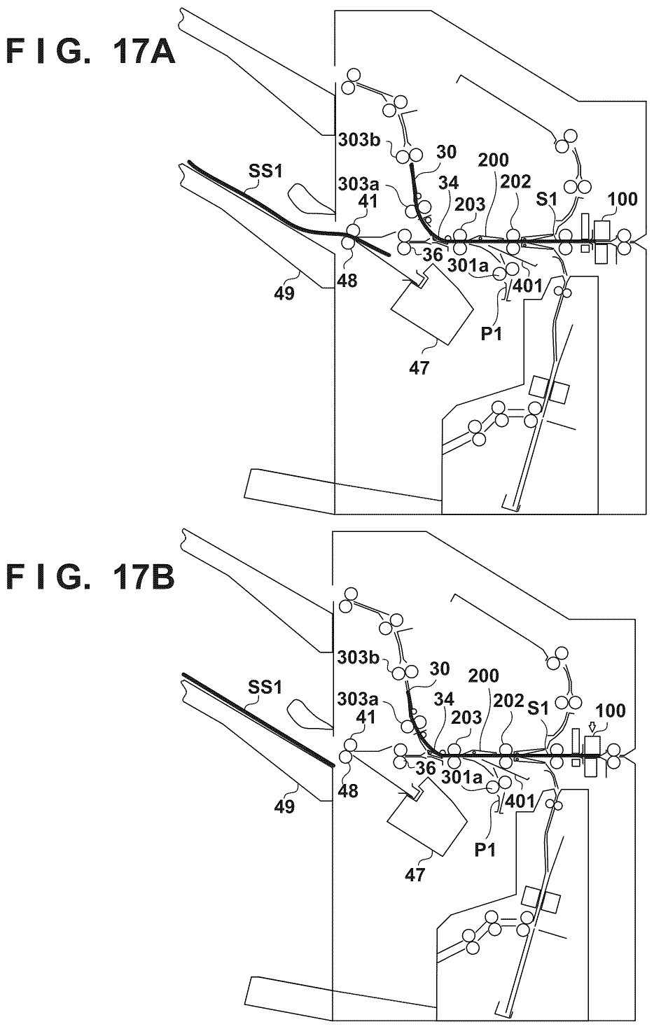

FIG. 17A shows a state in which the sheet S1 is conveyed up to the upper conveyance rollers 303b. At this time, the processing of the binding unit 47 for the preceding sheet bundle SS1 is completed, and discharge of the preceding sheet bundle SS1 to the first tray 49 is started.

FIG. 17B shows a state in which the conveyance direction of the sheet S1 is reversed, and the sheet S1 is conveyed up to the position of the punch unit 100. The punch unit 100 punches punch holes in the sheet S1. At this time, the preceding sheet bundle SS1 is discharged to the first tray 49.

FIG. 18A shows a state in which after punching processing of the punch holes by the punch unit 100, the conveyance direction of the sheet S1 is reversed, and the sheet S1 is conveyed again up to the upper conveyance path 30. The sheet S1 is conveyed up to a position where the trailing edge passes through the second conveyance rollers 202. The sheet support 401 then moves from the support position to the standby position. The processing unit buffer path flapper 200 can thus pivot downward.

FIG. 18B shows a state in which the conveyance direction of the sheet S1 is reversed, and the conveyance direction of the sheet S1 is changed by pivot of the processing unit buffer path flapper 200. The sheet S1 is thus conveyed in the reverse direction to the processing unit buffer path P1.

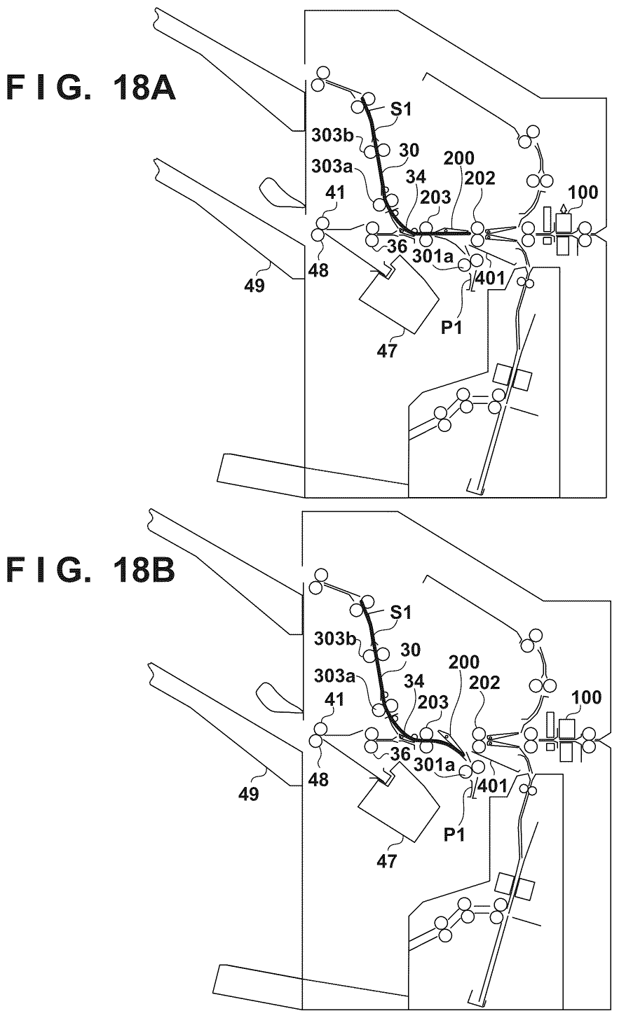

FIG. 19A shows a state in which the sheet S1 has passed through the processing unit buffer rollers 301a and is conveyed on the processing unit buffer path P1.

FIG. 19B shows a state in which the processing unit buffer rollers 301a stop, and the sheet S1 retreats to the processing unit buffer path P1. FIG. 19B also shows a state in which a sheet S2 is sent from the image forming apparatus A. The sheet S2 corresponds to the second sheet of the sheet bundle to be processed, together with the sheet S1, by the binding unit 47 at the subsequent stage. In the drawings, the sheet S2 is indicated by a dotted line for the discrimination between the sheets.

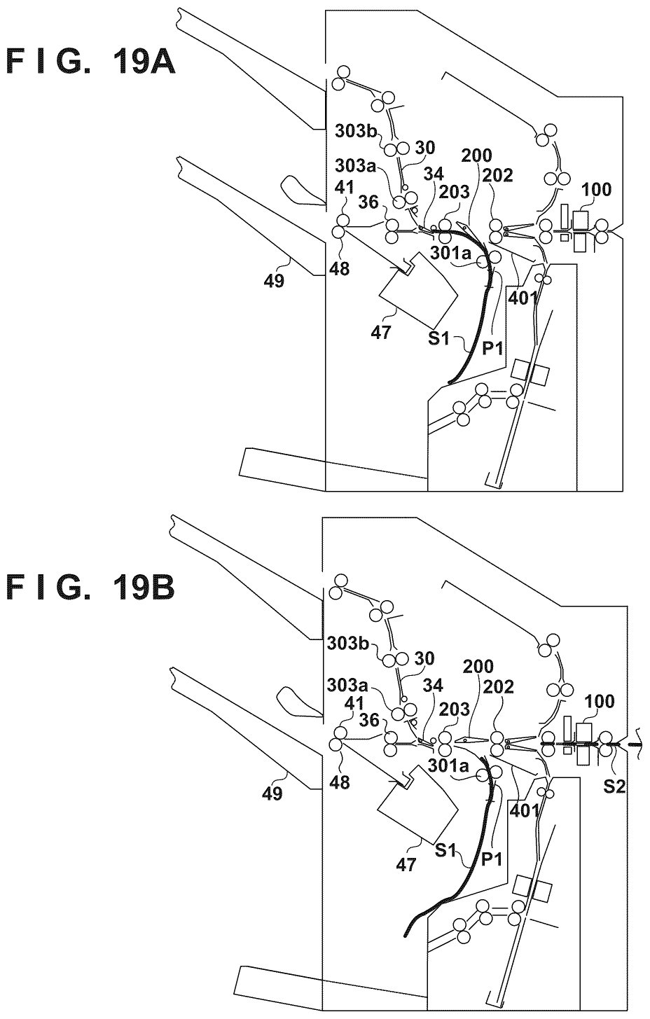

FIG. 20A shows a state in which the sheet support 401 moves to the support position. This can prevent the leading edge of the sheet S2 from hanging down to cause jam or the like or prevent the sheet S2 from unexpectedly coming into contact with the sheet S1 retreated to the processing unit buffer path P1.

FIG. 20B shows a state in which the sheet S1 and the sheet S2 are synchronously conveyed. In this embodiment, these are conveyed such that the leading edge of the sheet S1 is delayed by a predetermined interval from the leading edge of the sheet S2. Synchronization of the conveyance operation between the sheets here is performed by conveyance control by pulse count based on, for example, a detection timing at which the sheet is supplied from the image forming apparatus A to the straight path inlet 26. The leading edges of the sheets of the sheet bundle are thus sequentially shifted. Hence, when the sheet bundle is raked into the rear end portion of the sheet placement surface 37a of the processing tray 37 by the raking rotation body 46 at the subsequent stage, the sheets sequentially come into contact with the rear end portion, and the operation can be performed such that the sheets contact the rear end portion in a state in which the leading edge portions of all the sheets of the sheet bundle are aligned.

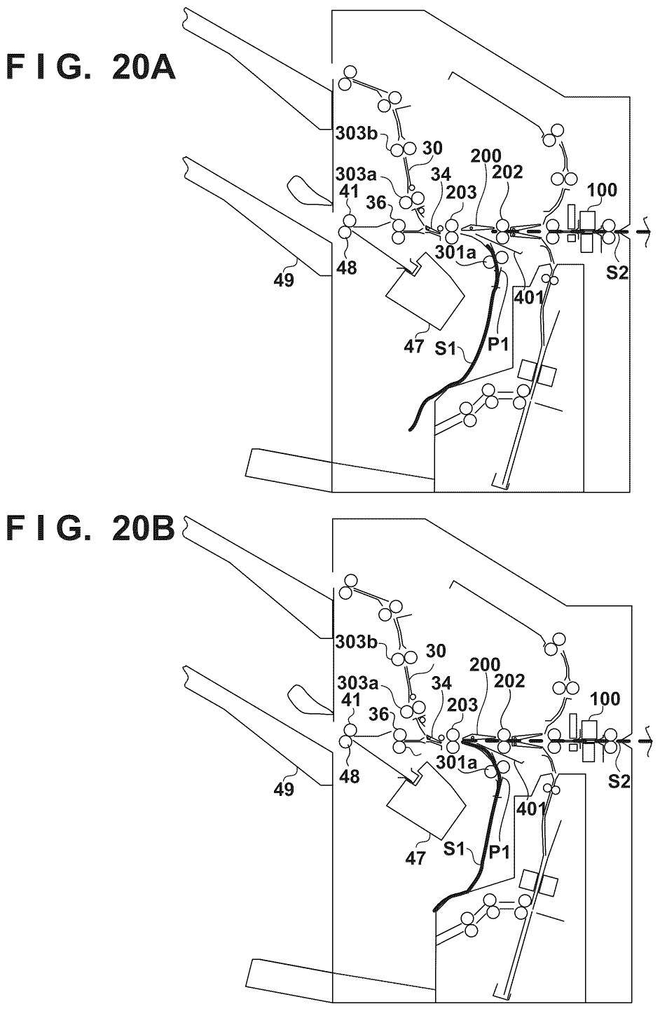

FIG. 21A shows a state in which the sheet S1 and the sheet S2 are conveyed synchronously on the upper conveyance path 30 in an overlapped state. Here, the trailing edge of the sheet S2 passes through the punch unit 100. When the sheet S1 and the sheet S2 are conveyed up to a predetermined position on the upper conveyance path 30, the conveyance direction of the sheet S1 and the sheet S2 is reversed.

FIG. 21B shows a state in which the conveyance direction of the sheet S1 and the sheet S2 is reversed, and the sheet S2 is conveyed up to the punch unit 100. Here, the sheet S1 is conveyed up to the processing unit buffer path P1. Even in the conveyance here, the sheet S1 and the sheet S2 are synchronously conveyed. The punch unit 100 punches punch holes in the sheet S2.

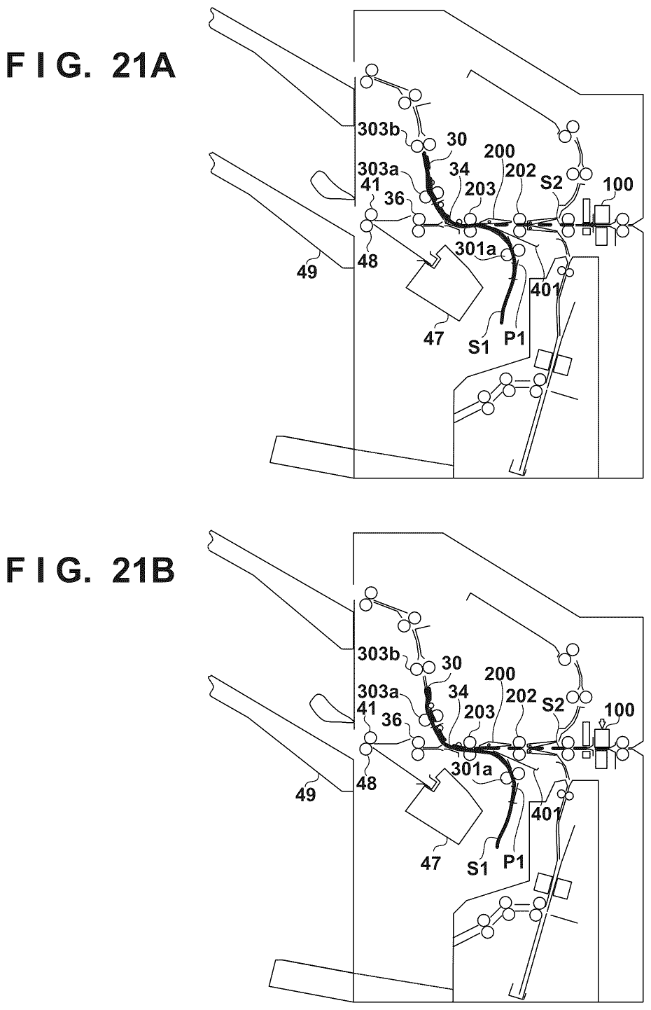

FIG. 22A shows a state in which after punching of the punch holes by the punch unit 100, the punch unit 100 moves to the retreat position.

FIG. 22B shows a state in which the conveyance direction of the sheet S1 and the sheet S2 is reversed, and the sheet S1 and the sheet S2 are synchronously conveyed up to a predetermined position on the upper conveyance path 30 in an overlapped state. The sheet support 401 moves from the support position to the standby position. The processing unit buffer path flapper 200 can thus pivot downward.

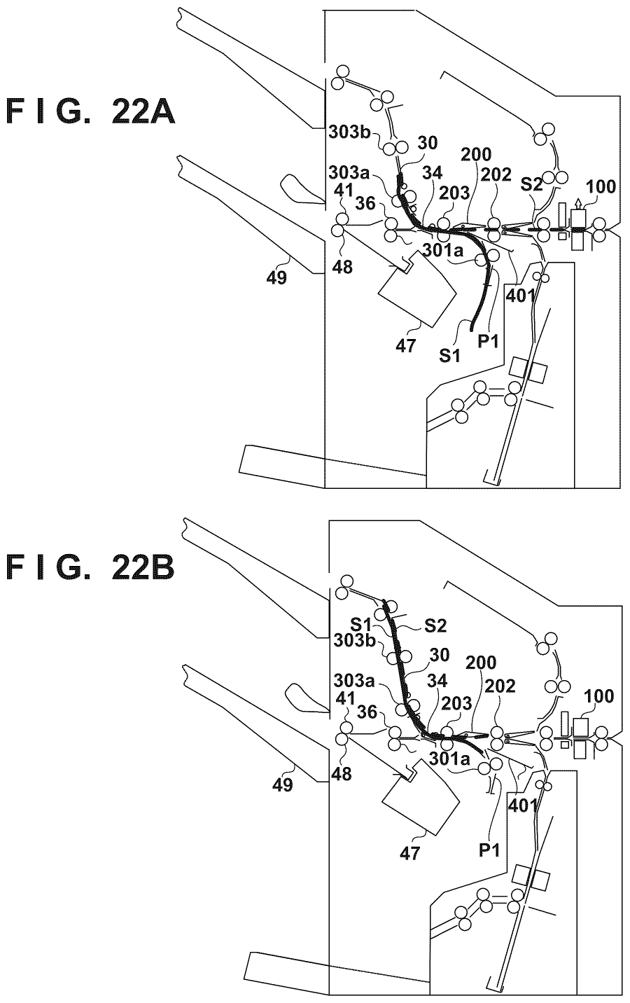

FIG. 23A shows a state in which the conveyance direction of the sheet S1 and the sheet S2 is reversed, and the conveyance direction of the sheets is changed by pivot of the processing unit buffer path flapper 200. The sheet S1 and the sheet S2 are thus guided to the processing unit buffer path P1. Even in the conveyance here, the sheet S1 and the sheet S2 are synchronously conveyed.

FIG. 23B shows a state in which the processing unit buffer rollers 301a stop, and the sheet S1 and the sheet S2 retreat to the processing unit buffer path P1.

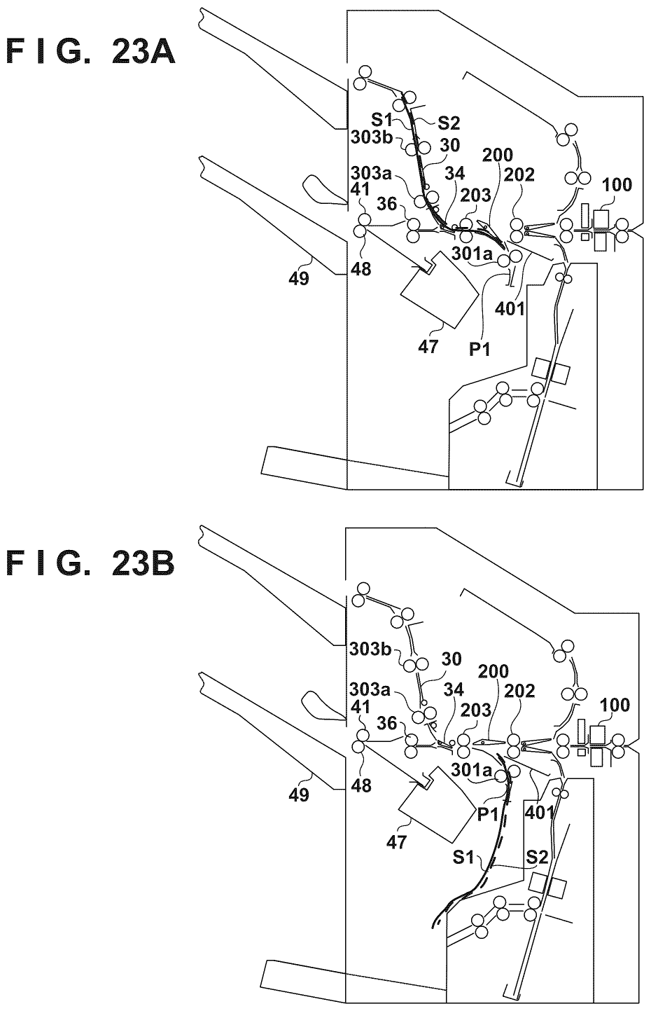

FIG. 24A shows a state in which a sheet S3 is sent from the image forming apparatus A. The sheet S3 corresponds to the third sheet (final sheet) of the sheet bundle to be processed by the binding unit 47 at the subsequent stage. At this time, the sheet support 401 moves from the standby position to the support position. This can prevent the leading edge of the sheet S3 from hanging down to cause jam or the like or prevent the sheet S3 from unexpectedly coming into contact with the sheet S1 and the sheet S2 retreated to the processing unit buffer path P1. Also, at this time, the upper conveyance path flapper 34 changes from a state in which it is opened downward to a state in which it is opened upward.

FIG. 24B shows a state in which the processing unit buffer rollers 301a rotate, and the sheet S3, the sheet S1, and the sheet S2 are conveyed synchronously in an overlapped state. In this embodiment, these are conveyed such that the leading edge of the sheet S2 is delayed by a predetermined interval from the leading edge of the sheet S3. Synchronization of the conveyance operation between the sheets here is performed by conveyance control by pulse count based on, for example, a detection timing at which the sheet is supplied from the image forming apparatus A.

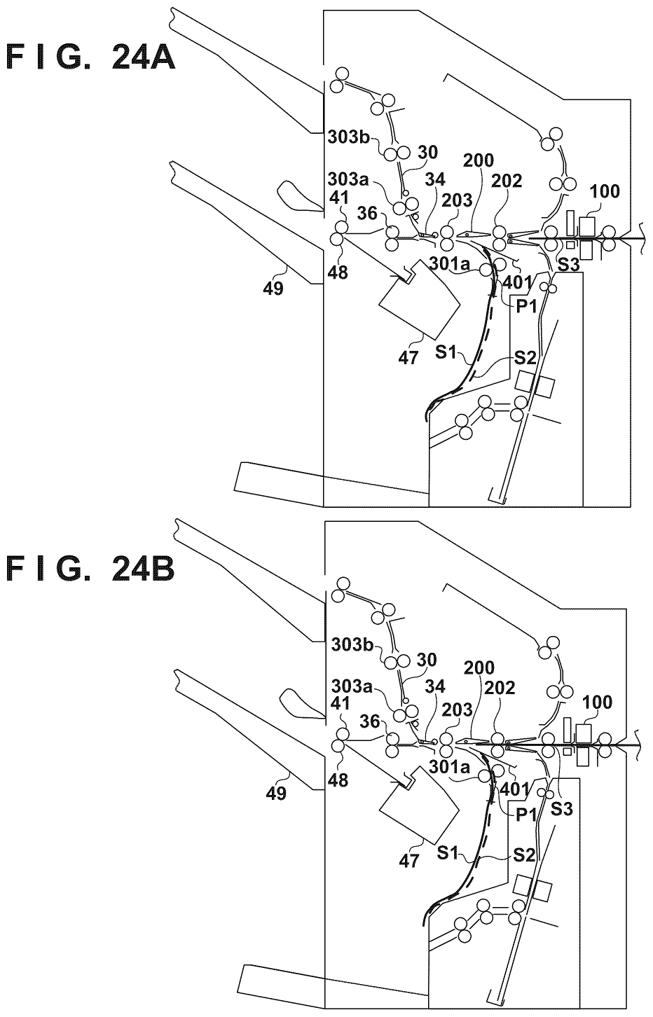

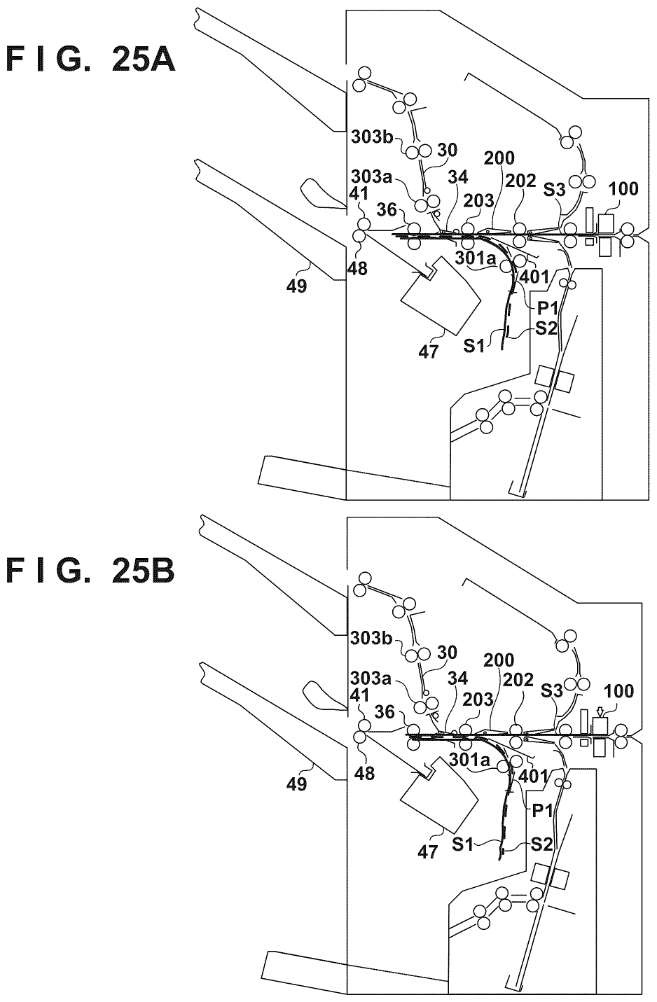

FIG. 25A shows a state in which the sheet S3, the sheet S1, and the sheet S2 are conveyed synchronously in an overlapped state. Here, since the upper conveyance path flapper 34 is opened upward, the sheet S1, the sheet S2, and the sheet S3 are conveyed in the direction of the elevating roller 41 and the driven roller 48.

FIG. 25B shows a state in which the conveyance direction of the sheet S3, the sheet S1, and the sheet S2 is reversed, and the sheet S3 is conveyed up to the punch unit 100. Here, the sheet S3, the sheet S1, and the sheet S2 are conveyed up to the processing unit buffer path P1. Even in the conveyance here, the sheet S3, the sheet S1, and the sheet S2 are synchronously conveyed. The punch unit 100 punches punch holes in the sheet S3.

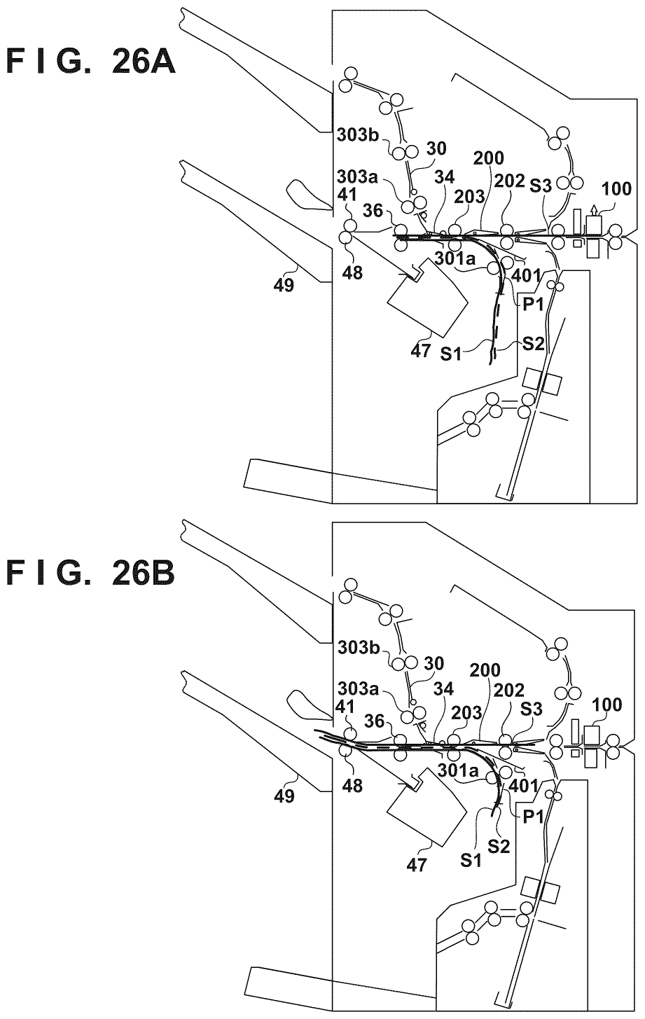

FIG. 26A shows a state in which after punching of the punch holes by the punch unit 100, the punch unit 100 moves to the retreat position.

FIG. 26B shows a state in which the conveyance direction of the sheet S1 to the sheet S3 is reversed, and the sheet S3, the sheet S1, and the sheet S2 are synchronously conveyed in an overlapped state.

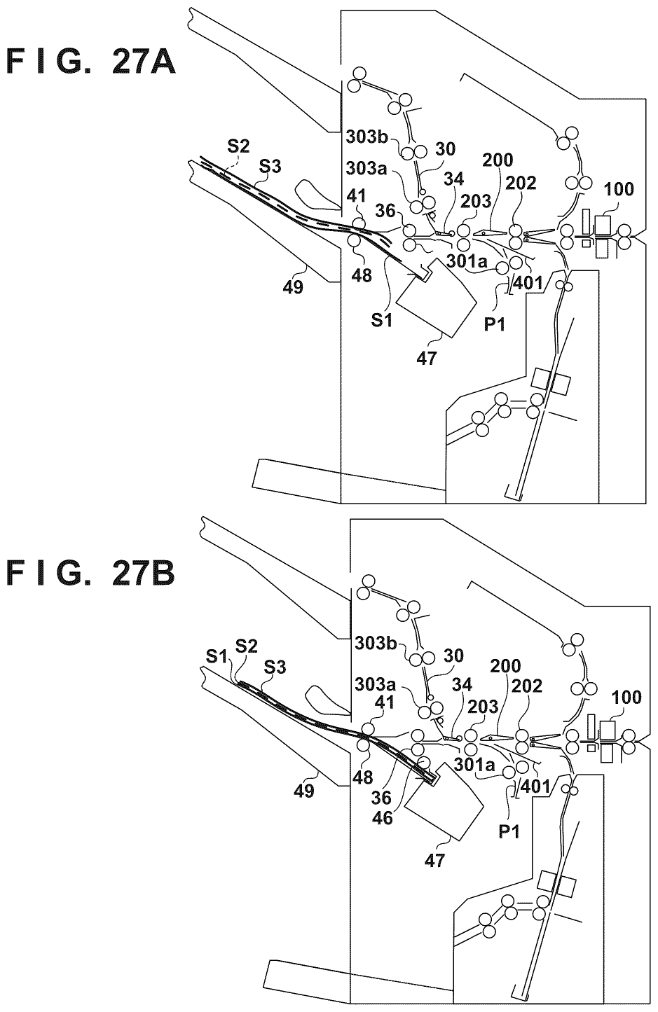

FIG. 27A shows a state in which the sheets are conveyed up to a position where the trailing edges of the sheet S1 to the sheet S3 pass through the discharge rollers 36. Then, the elevating roller 41 and the driven roller 48 rotate in reverse directions, thereby conveying the sheet bundle of the sheet S1 to the sheet S3 up to the binding unit 47.

FIG. 27B shows a state in which the sheet bundle of the sheet S1 to the sheet S3 is raked into the rear end portion of the sheet placement surface 37a of the processing tray 37 by the raking rotation body 46.

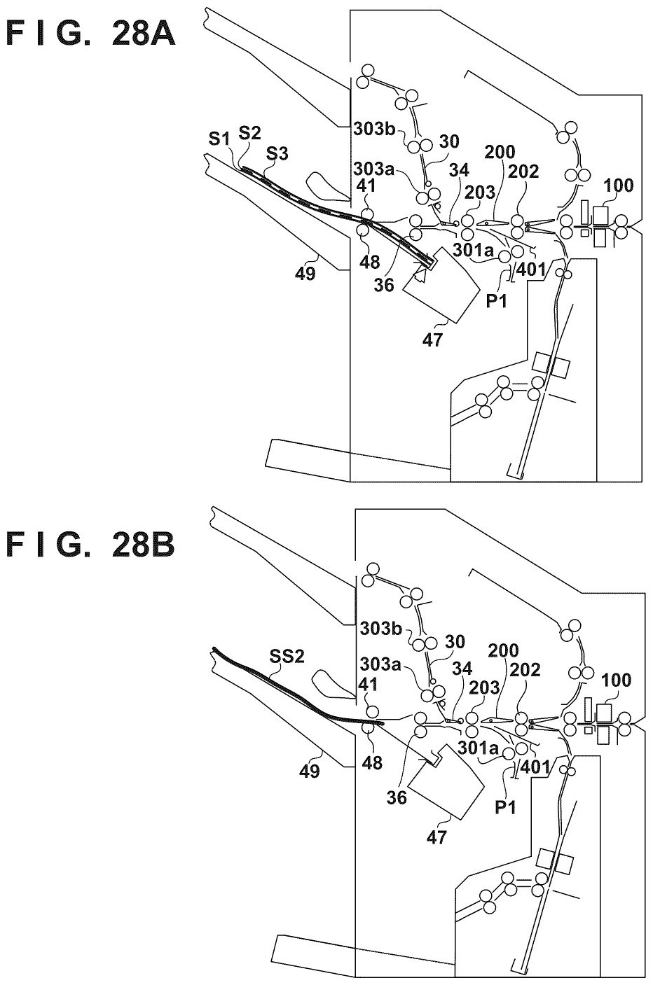

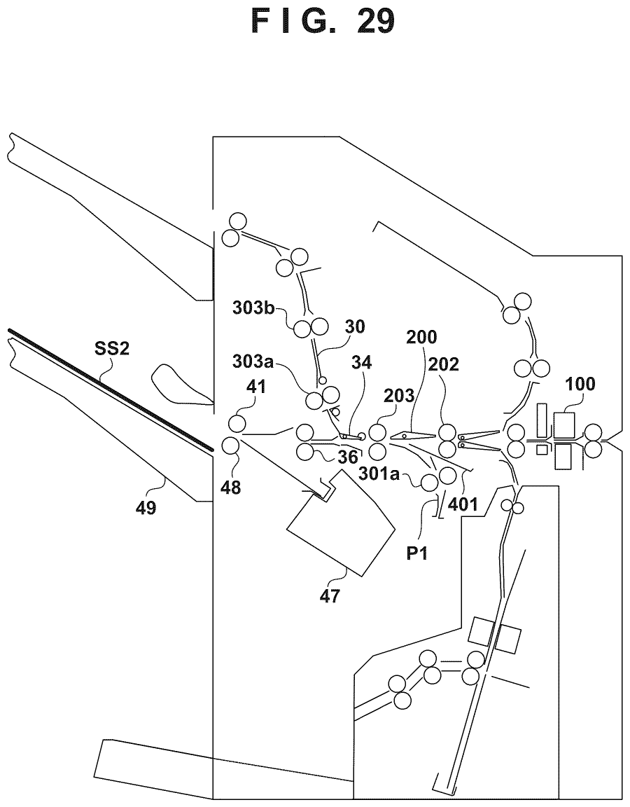

FIG. 28A shows a state in which the binding unit 47 performs binding processing for the sheet bundle of the sheet S1 to the sheet S3. FIG. 28B shows a state in which after binding processing by the binding unit 47, a sheet bundle SS2 of the sheet S1 to the sheet S3 is discharged to the first tray 49 by the elevating roller 41 and the driven roller 48. FIG. 29 shows a state in which the sheet bundle SS2 of the sheet S1 to the sheet S3 is discharged to the first tray 49.

The buffer operation according to this embodiment is effective when a preceding sheet bundle exists on the processing tray 37 of the binding unit 47, and a subsequent sheet is a predetermined size sheet longer than a predetermined length. More specifically, the predetermined size sheet indicates, for example, a sheet type like A3 size that is long in the conveyance direction and requires high productivity. For special long paper for which the productivity of the image forming apparatus main body needs to be low, the necessity of buffering cannot occur. Note that as the information of the sheet size, sheet information included in print setting information transmitted from the image forming apparatus main body is used.

Whether the subsequent sheet is the predetermined size sheet is determined based on how much the leading edge of the subsequent sheet projects onto the processing tray 37 when the trailing edge of the sheet is located at the branch of the processing unit buffer path P1. During binding processing of the binding unit 47, the elevating roller 41 and the driven roller 48 nip and stop. Hence, if the subsequent sheet projecting from the discharge rollers 36 reaches the nip point between the elevating roller 41 and the driven roller 48, the sheet is blocked and cannot be buffered. On the other hand, if the subsequent sheet projecting from the discharge rollers 36 does not reach the nip point between the elevating roller 41 and the driven roller 48, instead of sending the sheet to the upper conveyance path 30, the sheet may be switchback-conveyed to the processing unit buffer path P1 from a state in which the sheet stays on the straight path 28. In this case, since the sheet can be conveyed only by the third conveyance rollers 203, the number of rollers to be driven can be decreased.

Also, in this embodiment, a case where above-described predetermined size sheets, that is, sheets long in the conveyance direction are continuously bound has been described. The configuration is also effective even when connecting different jobs. For example, if a sheet bundle with A4 size on the processing tray 37 of the binding unit 47 is bound by a preceding job, and at least one sheet of A3 size is discharged to the first tray 49 by the subsequent job, the sheet can be sent without delaying image formation of the A3 sheet.

As described above, according to this embodiment, in the configuration in which post-processing is executed for sheets continuously supplied from the image forming apparatus A, the productivity can be further improved.

Note that an operation in a case where the preceding sheet bundle SS1 exists has been described above. If the preceding sheet bundle SS1 does not exist, the above-described buffer operation is not performed for a sheet supplied from the image forming apparatus A. In this case, for example, the above-described buffer operation to the upper conveyance path 30 is not performed for the sheet supplied from the image forming apparatus A, reverse conveyance from the straight path 28 to the processing unit buffer path P1 is performed, and after that, the sheet is conveyed up to the elevating roller 41 and the driven roller 48 in synchronism with a sheet newly supplied from the image forming apparatus A to the straight path inlet 26. Then, the elevating roller 41 and the driven roller 48 are rotated in the reverse direction, thereby conveying the sheet bundle to the binding unit 47.

In addition, the upper conveyance path 30 also serves as a path used to discharge a sheet to the third stack tray 71. Sheets of another job are loaded on the third stack tray 71 to prevent loading mixture with the first stack tray 49. The third stack tray 71 can also be used to discharge a sheet determined as an error sheet by an image error recognition unit (not shown) or a sheet remaining in the apparatus at the time of occurrence of an apparatus jam.

As for binding processing of the binding unit 47, in this embodiment, binding processing for binding sheets using needles has been described as an example. Various methods such as crimp binding for crimping and binding sheets and binding processing performed for several points can be employed. Even when performing post-processing that takes time, the operation can be performed without stopping the operation of the image forming apparatus. Also, when the subsequent sheet is sent to the upper conveyance path 30, it is possible not only to avoid the nip point between the elevating roller 41 and the driven roller 48 but also to avoid contact with a sheet on the processing tray 37, prevent disturbance to alignment of already loaded sheets, and avoid contact with other mechanisms in the processing tray 37.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-212307, filed Dec. 15, 2023, and Japanese Patent Application No. 2024-190841, filed Oct. 30, 2024 which are hereby incorporated by reference herein in their entirety.

What is claimed is:

1. A sheet binding processing apparatus comprising:
a conveyance path configured to convey a sheet from a path inlet to a path outlet;
a conveyance unit provided in the conveyance path and configured to convey the sheet;
a tray configured to accept, from above, the sheet conveyed on the conveyance path;
a binding unit configured to perform a binding process for binding a sheet bundle on the tray;
a pair of discharge rollers configured to discharge the sheet bundle that is performed the binding process by the binding unit;
a buffer path branching downward from the conveyance path and configured to, if a preceding sheet bundle exists on the tray, buffer a sheet that forms a subsequent sheet bundle;
a buffer conveyance unit provided on the buffer path and configured to convey the sheet;
an upper branching path branching upward from the conveyance path;
an upper conveyance unit provided on the upper branching path and configured to convey the sheet; and
a control unit configured to, when performing the binding process for continuously binding a sheet bundle including a predetermined sheet which is larger than a predetermined length in a conveyance direction, control the conveyance unit, the buffer conveyance unit, and the upper conveyance unit such that a sheet that forms a subsequent sheet bundle is sent from the conveyance path to the upper branching path, and the sheet is then conveyed in a switchback direction from the upper branching path to the buffer path.

2. The apparatus according to claim 1, wherein if the subsequent sheet is a predetermined sheet shorter than the predetermined length in the conveyance direction, the control unit controls not to send the sheet from the conveyance path to the upper branching path but to convey the sheet to the buffer path in the switchback direction and buffer the sheet.

3. The apparatus according to claim 1, further comprising:
a first stack tray on which the sheet discharged by the pair of discharge rollers are placed; and
a second stack tray provided above the first stack tray,
wherein the sheet conveyed on the conveyance path can be conveyed to the upper branching path and discharged to the second stack tray.

4. An image forming system comprising:
an image forming apparatus configured to perform image formation on a sheet; and
a sheet binding processing apparatus defined in claim 1.

5. A sheet binding processing apparatus comprising:
a conveyance path configured to convey a sheet from a path inlet to a path outlet;
a conveyance unit provided in the conveyance path and configured to convey the sheet;
a tray configured to accept, from above, the sheet conveyed on the conveyance path;
a binding unit configured to perform a binding process for binding a sheet bundle on the tray;
a pair of discharge rollers configured to discharge the sheet bundle that is performed the binding process by the binding unit;
a buffer path branching downward from the conveyance path and configured to, if a preceding sheet bundle exists on the tray, buffer a sheet that forms a subsequent sheet bundle;
a buffer conveyance unit provided on the buffer path and configured to convey the sheet;
an upper branching path branching upward from the conveyance path;
an upper conveyance unit provided on the upper branching path and configured to convey the sheet; and
a control unit configured to, if the sheet bundle of the preceding job exists on the tray, and the sheet of the subsequent job is a predetermined sheet longer than a predetermined length in a conveyance direction, control the conveyance unit, the buffer conveyance unit, and the upper conveyance unit such that the sheet of the subsequent job is sent from the conveyance path to the upper branching path, and the sheet is then conveyed in a switchback direction from the upper branching path to the buffer path.

6. The apparatus according to claim 5, wherein if the subsequent sheet is a predetermined sheet shorter than the predetermined length in the conveyance direction, the control unit controls not to send the sheet from the conveyance path to the upper branching path but to convey the sheet to the buffer path in the switchback direction and buffer the sheet.

7. The apparatus according to claim 5, further comprising:
a first stack tray on which the sheet discharged by the pair of discharge rollers are placed; and
a second stack tray provided above the first stack tray,
wherein the sheet conveyed on the conveyance path can be conveyed to the upper branching path and discharged to the second stack tray.

8. An image forming system comprising:
an image forming apparatus configured to perform image formation on a sheet; and
a sheet binding processing apparatus defined in claim 5.
